(19) United States
(12) Patent Application Publication
(10) Pub. No.: US 2025/0211980 A1
(43) Pub. Date: Jun. 26, 2025

(54) Systems and Methods for Accessing Network Services in a Wireless Communication Network

(71) Applicant: HUAWEI TECHNOLOGIES CO., LTD., SHENZHEN (CN)

(72) Inventors: Xu LI, Kanata (CA); Bidi YING, Kanata (CA); Chenchen YANG, Guangdong (CN); Weisen SHI, Kanata (CA)

(73) Assignee: HUAWEI TECHNOLOGIES CO., LTD., SHENZHEN (CN)

(21) Appl. No.: 19/079,990

(22) Filed: Mar. 14, 2025

Related U.S. Application Data
(63) Continuation of application No. PCT/CN2022/124231, filed on Oct. 10, 2022.

(51) Int. Cl. H04W 12/037; H04W 12/08

(52) U.S. Cl. CPC H04W 12/037; H04W 12/08

(57) ABSTRACT

The disclosure provides for systems and methods for systems and methods for accessing network services in a wireless communication network. According to an aspect a method performed by an access manager (AM) is provided. The method includes receiving, from a device, a request for a network service (NS). The request includes information identifying the NS and an NS context identifier (ID). The method further includes processing the request according to a network service access protocol (NSAP) context on the AM. The method further includes selecting a network service function (SNF). The method further includes sending, to the NSF, a service request notification including the information identifying the NS and the NS context ID. The method further includes receiving, from the NSF, a service response. The method further includes sending to the device, a response message including the NS context ID and the service response.

### CROSS REFERENCE TO RELATED APPLICATION

This application is a continuation of International Application No. PCT/CN2022/124231, filed on Oct. 10, 2022, the disclosure of which is hereby incorporated by reference in its entirety.

### TECHNICAL FIELD

The present disclosure pertains to the field of communication networks, and in particular to systems and methods for accessing network services in a wireless communication network.

### BACKGROUND

In wireless communication networks (e.g., 5G wireless networks), a user equipment (UE) has a single non-access stratum (NAS) interface in the core network (CN). The NAS interface terminates at a network function, e.g., an access and mobility management function (AMF), in the CN. The UE communicates with one or more CN functions via the NAS terminating point (e.g., the AMF), and the communication can be secured using NAS security mechanism. Thus, UE's communication with the one or more CN functions is dependent on the NAS termination point, a CN function, which acts as a relay between the UE and the CN functions. Such dependence may unnecessarily limit UE's ability to communicate with the one or more CN functions.

While UE communication with multiple CN functions, without relying on some CN relay function, has been considered, such efforts have been inadequate. Particularly with respect to an efficient mechanism for supporting NAS security. For example, whether different NAS security parameters should be used for different CN functions, and how should the NAS security parameters be distributed and updated.

In addition to challenges involved in improving UE communication with multiple CN functions, the potential availability of radio access network (RAN)-provided network services poses additional challenges. For example, how the UE may communicate with network functions both in the CN and the RAN. Further, whether such UE communication should be secured, and if so, how to secure such UE communication, are challenges that are yet to be attended to.

Therefore, there is a need for systems and methods for accessing network services in a wireless communication network that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

The disclosure provides for systems and methods for accessing network services in a wireless communication network. According to an aspect a method is provided. The method includes receiving, by an access manager (AM) from a radio access network (RAN) node, a first request for a network service (NS), the first request including information identifying the NS and an NS context identifier (ID) identifying the NS context. The method further includes selecting, by the AM, a network service function (SNF) according to the first request. The method further includes sending, by the AM to the NSF, a service request notification including information in the first request. The method further includes receiving, by the AM from the NSF, a service response corresponding to the service request notification and indicating whether the information in the first request for NS has been accepted. The method further includes sending, by the AM to the RAN node, a response message including the NS context ID and an encrypted service response, wherein the encrypted service response is obtained by encrypting the service response.

In some embodiments, the first request for the NS may include one or more of: a service name or ID, a device ID, a slice ID, an application ID, a data network ID, one or more NS operations to be performed with respect to NS context identified by the NS context ID, and an ID for each of the one or more NS operations.

In some embodiments, the first request for the NS is obtained by the RAN node re-encrypting a second request with a public key related to the AM according to a network service access protocol (NSAP) handling rule of an NSAP context on the RAN node. The method may further include, before selecting the NSF, decrypting, by the AM, the first request using a private key included in an NSAP context on the AM.

In some embodiments, the second request is from a device to the RAN node, the second request being encrypted with a public key of the device according to an NSAP handling rule of an NSAP context on the device, the NSAP context on the device being associated with the NS context ID.

In some embodiments, selecting, by the AM, the NSF according to the first request includes sending, by the AM to a network binding function (NBF), a third request to identify the NSF, the third request comprising the NS context ID and receiving, by the AM from the NBF, a response indicating the NSF.

In some embodiments, selecting, by the AM, the NSF according to the request includes sending, by the AM to a network registry function (NRF), a third request to identify the NSF, the third request comprising a location of the device and NS information and receiving, by the AM from the NRF, a response indicating the NSF and a location of the NSF.

In some embodiments, selecting, by the AM, the NSF according to the first request includes sending, by the AM to a network function, a third request, the third request including any of a location of the device, the NS information and the NS context ID and receiving, by the AM from the network function, a response indicating the NSF and a location of the NSF.

In some embodiments, selecting, by the AM, the NSF according to the first request includes selecting the NSF based on one or more of the network service provided by the NSF and identified in the NS information, a service area of the NSF covering the location of the device, the location of the NSF, the NSF belonging to a network slice as identified in the NS information and the NSF being configured to serve an application, a sub-system, or a specialized networks service as identified in the NS information.

In some embodiments, the service response includes one or more of the NS context ID, an NS session ID, a first indication indicating that an NS session identified by the NS session ID is a newly created NS session, a second indication indicating that one or more NSAP security parameters are needed for the NS session and routing information for reaching the NSF for the NS session.

In some embodiments, the encrypted service response is obtained by the AM encrypting the service response with a key of the AM according to a NSAP context on the AM.

In some embodiments, the response message includes a command indicating whether to apply NSAP security to the NS context identified by the NS context ID.

In some embodiments, the method further includes determining, by the AM, to apply NSAP security parameters to the NS context based on a location of the NSF and allocating, by the AM, NSAP security parameters to support secure communication between a device and the NSF, the communication related to the NS context.

In some embodiments, the location of the NSF is in one of a core network (CN) of a wireless communication network and a RAN of the wireless communication network and located outside of an area covered by the RAN node of the device.

In some embodiments, the NSAP security parameters includes a device public key and a device private key and the method further includes sending, by the AM to the RAN node, a device key message comprising at least one of the device public key and the device private key.

In some embodiments, the method further includes receiving, by the AM from the RAN node, an acknowledgement of receipt of the device key message.

In some embodiments, the device key message is encrypted with a secret key and the method further includes negotiating, by the AM, with the device a secret key.

In some embodiments, the NSAP security parameters comprises an uplink (UL) re-encryption key associated with the NS session and a downlink (DL) re-encryption key associated with the device.

In some embodiments, the method further includes sending, by the AM to the RAN node, a RAN configuration request including one or more of: the NS context ID, a NS session ID, a NSF ID or address, a routing information for reaching the NSF, a command indicating whether to apply NSAP security to the NS context, the UL re-encryption key, and the DL re-encryption key.

In some embodiments, the method further includes receiving, by the AM from the RAN node, a RAN response indicating receipt of the RAN configuration request.

In some embodiments, the NSAP security parameters comprises an NSF public key and an NSF private key.

In some embodiments, the method further includes sending, by the AM to the NSF, an NSF configuration request comprising one or more of: an ID of the RAN node, a command indicating whether to apply NSAP security to the NS context, the NSF public key and the NSF private key.

In some embodiments, the method further includes receiving, by the AM from the NSF, an NSF response indicating receipt of the NSF configuration request.

According to another aspect, a method is provided. The method includes sending, by a device, a second request for a network service (NS) to a radio access network (RAN) node, the second request including information identifying the NS and an NS context identifier (ID) identifying the NS context. The method further includes receiving, by the device, a network message including the NS context ID and a re-encrypted service response, the re-encrypted service response indicates whether information in the second request has been accepted.

In some embodiments, the network message further comprising a command indicating whether to apply network service access protocol (NSAP) security to the NS context.

In some embodiments, the method further includes updating, by the device, an NSAP context on the device according to the network message and performing, by the device, secure communication with a network service function (NSF) according to the NSAP context on the device, the secure communication related to the NS context.

In some embodiments, the network message further includes one or more keys for supporting the secure communication, the one or more keys comprising: a device public key and a device private key. In some embodiments, the method further includes encrypting, by the device, an uplink (UL) NSAP message using the device public key and sending, by the device to the RAN node, the encrypted UL NSAP message.

In some embodiments, the method further includes receiving, by the device from the RAN node, a re-encrypted downlink (DL) NSAP message and decrypting, by the device, the re-encrypted DL NSAP message using the device private key.

According to another aspect, a method is provided. The method includes receiving, by a radio access network (RAN) node from a device, a second request for a network service (NS), the second request includes information identifying the NS and an NS context identifier (ID) identifying the NS context. The method further includes obtaining, by the RAN rode, a first request by encrypting the second request and sending, by the RAN node to the AM, the first request for the NS. The method further including receiving, by the RAN node from the AM, a response message including the NS context ID and an encrypted service response, wherein the encrypted service response corresponds to the first request for NS and indicates whether the first request for NS has been accepted. The method further includes sending, by the RAN node, a network message comprising the NS context ID and a re-encrypted service response to the device, the re-encrypted service response is obtained by re-encrypting the encrypted service response.

In some embodiments, the first request is obtained by encrypting the second request with a public key relate to the AM according to an NSAP handling rule of an NASP context on the RAN node.

In some embodiments, the method further includes receiving, by the RAN node from the AM, a RAN configuration request includes one or more of: the NS context ID, a NS session ID, a NSF ID or address, a routing information for reaching the NSF, a command indicating whether to apply NSAP security to the NS context, a UL re-encryption key, and a DL re-encryption key.

In some embodiments, the method further includes receiving, by the RAN node from the AM, a device key message comprising at least one of: a device public key and a device private key. The method further including sending, by the RAN node to the device, a network message comprising one or more of: the NS context ID, a command indicating whether to apply network service access protocol (NSAP) security to a network service (NS) context identified by the NS context ID, the device public key and the device private key.

In some embodiments, the method further includes sending, by the RAN node to the AM, an acknowledgement of receipt of the device key message.

In some embodiments, the method further includes receiving, by the RAN node from the device, an encrypted UL NSAP message. The method further including re-encrypting, by the RAN node, the encrypted UL NSAP message using the UL re-encryption key and sending, by the RAN node to the NSF, the re-encrypted UL NSAP message.

In some embodiments, the method further includes receiving, by the RAN node from the NSF, an encrypted DL NSAP message. The method further including re-encrypting, by the RAN node, the encrypted DL NSAP message using the DL re-encryption key and sending, by the RAN node to the device, the re-encrypted DL NSAP message.

According to another aspect, a method is provided. The method includes receiving, by a network service function (NSF) from an access manager (AM), a service request notification, the service request notification includes information identifying a network service (NS) and an NS context identifier (ID) identifying NS context. The method further including sending, a service response corresponding to the service request notification and indicating whether the service request notification has been accepted.

In some embodiments, the method further includes updating, by the NSF, an NSAP context on the NSF according to the service request notification and performing, by the NSF, secure communication with a device according to the NSAP context on the NSF, the secure communication related to the NS context.

In some embodiments, the service request notification further includes one or more of: a command indicating whether to apply network service access protocol (NSAP) security to a NS context identified by the NS context ID, an NSF public key for supporting the secure communication; an NSF private key for supporting the secure communication; and ID of a radio access network (RAN) node serving the device.

In some embodiments, performing, by the NSF, the secure communication with the device includes encrypting, by the NSF, a downlink (DL) NSAP message using the NSF public key and sending, by the NSF to the RAN node, the encrypted DL NSAP message.

In some embodiments, performing, by the NSF, the secure communication with the device includes receiving, by the NSF from the RAN node, a re-encrypted uplink (UL) NSAP message and decrypting, by the NSF, the re-encrypted UL NSAP message using NSF private key.

In some embodiments, the method further includes receiving, by the NSF from the AM, a service request notification comprising one or more of: NS information and NS operation instruction.

According to another aspect, a method is provided. The method includes sending, by a device, a second request for a network service (NS) to a radio access network (RAN) node, the second request comprising information identifying the NS and an NS context identifier (ID) identifying the NS context. The method further includes obtaining, by the RAN rode, a first request by encrypting the second request and sending, by the RAN node to an access manager (AM), the first request for the NS. The method further includes selecting, by the AM, a network service function (NSF) according to the first request and sending, by the AM to the NSF, a service request notification including information in the first request. The method further includes receiving, by the AM from the NSF, a service response corresponding to the service request notification and indicating whether the information in the first request for NS has been accepted and sending, by the AM to the RAN node, a response message including the NS context ID and an encrypted service response, wherein the encrypted service response is obtained by encrypting the service response. The method further includes sending, by the RAN node to the device, a network message comprising the NS context ID and a re-encrypted service response, the re-encrypted service response is obtained by re-encrypting the encrypted service response

According to another aspect, a method is provided. The method includes receiving, by a radio access network (RAN) node from a device, a request message for a network service (NS) associated with an NS context, the request message including information identifying the NS and an NS context identifier (ID) identifying the NS context. The method further includes determining, by the RAN node, an NS session associated with the NS context ID according to a network service access protocol (NSAP) context on the RAN node. The method further includes sending, by the RAN node to a network service function (NSF), the request message using the NS session. The method further includes receiving, by the RAN node from the NSF, a response message including the NS context and indicating that the request for the NS has been accepted. The method further includes sending, by the RAN node to the device, the response message.

In some embodiments, the request message further comprises one or more of: a service name or ID, a device ID, a slice ID, application ID, a data network ID, one or more NS operations to be performed with respect to the NS context identified by the NS context ID, and an ID for each of the one or more NS operations.

In some embodiments, the request message is encrypted via a public key of the device and the method further includes re-encrypting, by the RAN node, the encrypted request message using an uplink (UL) re-encryption key based on the NSAP context on the RAN node indicating to apply NSAP security on the request message.

In some embodiments, the method further includes receiving, by the RAN node from the device, a first indication, the first indication indicates that the request message is encrypted.

In some embodiments, the response message is encrypted via a public key of the NSF and the method further includes re-encrypting, by the RAN node, the encrypted response message using a downlink (DL) re-encryption key based on the NSAP context on the RAN node indicating to apply NSAP security on the response message.

In some embodiments, the method further includes receiving, by the RAN node from the device, a second indication, the second indication indicates that the response message is encrypted.

According to another aspect, a method is provided. The method includes receiving, by an access manager (AM), an indication to relocate a serving network service function (NSF) of a network service (NS) context from an old NSF to a new NSF and reselecting or selecting, by the AM, the new NSF to serve the NS context. The method further includes sending, by the AM to the new NSF, a first relocation notification comprising an NS context identifier (ID) identifying the NS context and information identifying the old NSF and receiving, by the AM from the new NSF, a first relocation response. The method further includes sending, by the AM to a device associated with the NS context, a first network message including a first command indicating to pause communication associated with the NS context ID.

In some embodiments, reselecting or selecting, by the AM, the new NSF to serve the NS context includes sending, by the AM to a network registry function (NRF), a request to identify the new NSF, the request including a location of the device and NS information and receiving, by the AM from the NRF, a response indicating the new NSF and a location of the new NSF.

In some embodiments, receiving, by the AM from the new NSF, the first relocation response includes receiving, by the AM from the new NSF, one or more of: an NS session ID associated with the NS context ID, a first indication indicating whether the NS session identified by the NS session ID is a newly created NS session, a second indication indicating that one or more NSAP security parameters are needed for the NS session; and routing information for the NS session.

In some embodiments, a location of the new NSF is different from a location of the old NSF and the method further includes determining, by the AM, to apply NSAP security parameters to the NS context and allocating, by the AM, NSAP security parameters to support secure communication between the device and the new NSF, the communication related to the NS context.

In some embodiments, allocating, by the AM, the NSAP security parameters comprises allocating, by the AM, an uplink (UL) re-encryption key associated with the NS session and a downlink (DL) re-encryption key associated with the device. The method further including sending, by the AM to the RAN node, a RAN configuration request comprising one or more of: the NS context ID, the NS session ID, the new NSF ID or address, first NSAP command indicating whether to apply NSAP security to the NS context, the routing information for reaching the new NSF, the UL re-encryption key, and the DL re-encryption key and receiving, by the AM from the RAN node, a RAN response indicating receipt of the RAN configuration request.

In some embodiments, allocating, by the AM, the NSAP security parameters comprises allocating, by the AM, an NSF public key and an NSF private key. The method further includes sending, by the AM to the new NSF, an NSF configuration request comprising one or more of: an ID of the RAN node, a second NSAP command indicating whether to apply NSAP security to the NS context, the NSF public key and the NSF private key and receiving, by the AN from the new NSF, an NSF response indicating receipt of the NSF configuration request.

In some embodiments, the method further includes sending, by the AM to the old SMF, a second relocation notification comprising the NS context ID and information on the new NSF and receiving, by the AM from the old SMF, a second relocation response indicating that the NS context has been transferred to the new NSF. The method further includes sending, by the AM to the device, a second network message comprising a second command indicating to resume communication associated with the NS context ID.

According to another aspect, a system is provided. The system includes a device, an access manager (AM) and a radio access network (RAN) node. The device is configured to send a second request for a network service (NS) to the RAN node, the second request comprising information identifying the NS and an NS context identifier (ID) identifying the NS context. The RAN node is configured to obtain a first request by encrypting the second request and send the first request for the NS to the AM. The AM is configured to select a network service function (NSF) according to the first request and send a service request notification including information in the first request to the NSF. The AM is further configured to receive from the NSF, a service response corresponding to the service request notification and indicating whether the information in the first request for NS has been accepted and send to the RAN node, a response message including the NS context ID and an encrypted service response, wherein the encrypted service response is obtained by encrypting the service response. The RAN node is further configured to send to the device, a network message comprising the NS context ID and a re-encrypted service response, the re-encrypted service response is obtained by re-encrypting the encrypted service response.

According to another aspect, an apparatus is provided. The apparatus includes at least one processor and at least one machine-readable medium storing executable instructions. The executable instructions which when executed by the at least one processor configured the apparatus to perform one or more of the methods described herein.

According to another aspect, a computer device is provided. The computer device including a non-transitory computer readable medium having instructions stored thereon. The instructions when executed by a computer processor cause the computer device to perform one or more of the methods described herein.

According to one aspect, a chip is provided, where the chip includes a processor and a data interface, and the processor reads, by using the data interface, instructions stored in a memory, to perform one or more of the methods described herein.

Other aspects of the disclosure provide for apparatus, and systems configured to implement the methods according to the first aspect disclosed herein. For example, wireless stations and access points can be configured with machine readable memory containing instructions, which when executed by the processors of these devices, configures the device to perform one or more of the methods and systems described herein.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 illustrates a wireless communication network, according to an aspect.

FIG. 2 illustrates a network service access protocol (NSAP) layer, according to an aspect.

FIG. 3 illustrates a network service access protocol (NSAP) message, according to an aspect.

FIG. 4 illustrates an example of handling NSAP messages, according to an aspect

FIG. 5 illustrates a procedure for requesting a network service, according to an aspect.

FIG. 6 illustrates another procedure for request a network service, according to an aspect.

FIG. 7 illustrates a procedure for NSF relocation, according to an aspect.

FIG. 8 illustrates an apparatus that may perform any or all of operations of the above methods and features explicitly or implicitly described herein, according to different aspects of the present disclosure.

It will be noted that throughout the appended drawings, like features are identified by like reference numerals.

### DETAILED DESCRIPTION

In wireless communication networks (e.g., 5G wireless networks), a user equipment (UE) has a single non-access stratum (NAS) interface, which is terminated at a network function (e.g., an access and mobility management function (AMF)), in the core network (CN). This NAS interface is supported by the radio access network (RAN), wherein the RAN forwards messages communicated over the NAS interface. The UE can communicate with other CN functions (e.g., session management function (SMF), policy control function (PCF)), but the communication is via or goes through the NAS terminating point (e.g., the AMF). Messages communicated over the NAS interface can be secured using a NAS security mechanism, which is an end-to-end mechanism (between the UE and the NSA terminating point). As may be appreciated by a person skilled in the art, the RAN is not involved in the NSA security mechanism.

Direct communication between a UE and multiple CN functions has not yet been fully explored. Here ‘direct’ may refer to communication that does not rely on some CN function to relay a message, e.g., AMF's relay. Further development in determining an efficient mechanism for supporting NAS security may also be relevant. For example, whether different NAS security parameters should be used for different CN functions, and how should the NAS security parameters be distributed and updated.

In addition to challenges involved in improving UE communication with multiple CN functions, the potential availability of radio access network (RAN) provided network services pose additional challenges. For example, networks may offer both RAN-provided network services (by RAN functions) and CN-provided network services (by CN functions). How UE may communicate with these network functions is unclear. For example, whether such UE communication should be secured, and if so, how to secure such UE communication.

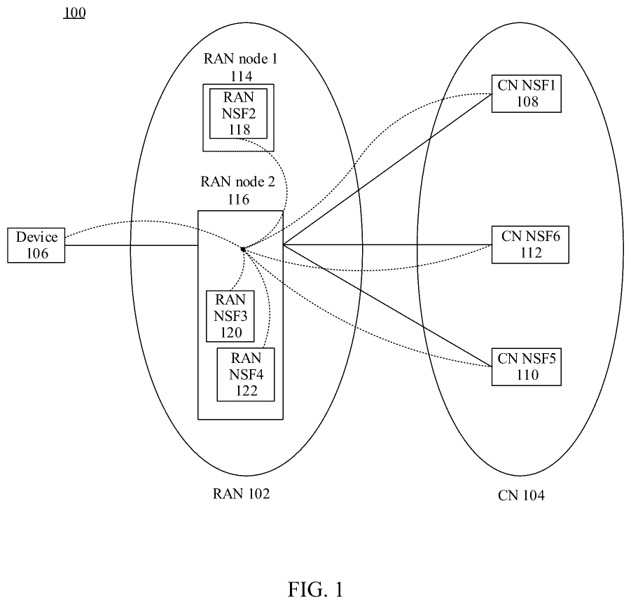

FIG. 1 illustrates a wireless communication network, according to an aspect. The wireless communication network 100 (the communication network) may include a RAN 102 and a CN 104. The communication network may offer one or multiple network services to a device 106 (e.g., a user equipment (UE)), via one or multiple network service functions (NSFs) in the communication network. Network services may include one or more of mobility management, session management, policy management, and other services. NSFs may include one or more of AMF, SMF, PCF, and other service functions. In some aspects, the one or multiple NSFs may be functions in the control plane of the communication network 100.

In an aspect, each of the one or multiple NSFs may provide access to one or more than one of the one or multiple network services. An NSF located in the CN 104 may correspondingly be referred to as a CN NSF. The CN 104 may include one or multiple CN NSFs, e.g., CN NSF1 108, CN NSF5 110, and CN NSF6 112.

An NSF located in the RAN 102 may correspondingly be referred to as a RAN NSF. The RAN 102 may include one or multiple RAN nodes, e.g., RAN node 1 114 and RAN node 2 116. A RAN node (e.g., RAN node 1 114 and RAN NODE 2 116) may include one or multiple RAN NSFs. In FIG. 1, RAN node 1 includes RAN NSF2 118, and RAN node 2 116 includes RAN NSF3 120 and RAN NSF4 122 as illustrated.

At least one of the one or multiple NSFs can provide an access management service, including managing a device's access to the network and selecting an NSF for the device to access a network service. The at least one of the one or multiple NSFs may be referred to as access manager (AM). As an NSF, an AM may be located in the CN or in the RAN as described herein.

A device 106 may connect to or accesses the communication network by connecting to a RAN node (e.g., RAN node2 116) in the RAN 102. The RAN node 116 is considered to be serving the device 106 and may be referred to as the serving RAN node of the device.

In some aspects, from the perspective of the device, the device 106 may use a single logical interface (as shown in dotted line) to access the one or multiple network services. The single logical interface may connect to one or multiple NSFs that provide access to the one or multiple network services, through a forking effect at the RAN node (e.g., RAN node 2 116). In the illustrated figure, the one or multiple NSFs includes CN NSF1 108, CN NSF5 110, CN NSF6 112, RAN NSF2 118, RAN NSF3 120, and RAN NSF4 122.

According to some aspects, depending on NSF location, dynamic activation and deactivation of security handling on the logical interface may be performed. In some aspects, when communication on the logical interface is secured, communication content is ciphered and not readable by the RAN or the serving RAN node. For example, communication between the device 106 and any of the one or multiple CN NSFs via the logical interface may be secured as needed, such that the content communicated between the device and the one or more CN NSFs is not readable by the RAN or the serving RAN node. Similarly, in some aspects, communication between the device and a RAN NSF (e.g., RAN NSF2 118) that is not located in the serving RAN node (RAN node 2 116) of the device may be secured, such that the content communicated between the device and the RAN NSF is not readable by the serving RAN node. However, in some aspects, communication between the device and a RAN NSF (e.g., RAN NSF3 120 or RAN NSF4 122) that is located in the serving RAN node (e.g., RAN node 2 116) may not be secured, in which the content communicated may be readable by the serving RAN node.

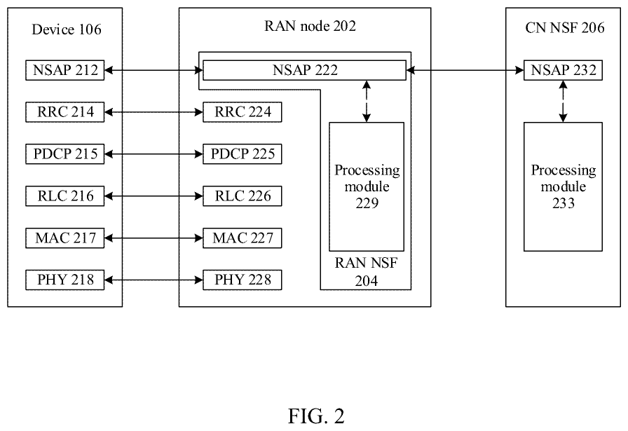

An aspect may provide for a protocol layer that spans devices, RAN nodes, and NSFs as illustrated in FIG. 2. FIG. 2 illustrates a network service access protocol (NSAP) layer, according to an aspect. The terms NSAP and NSAP layer may be used inter-changeably herein. In some aspects, RAN node 202 may be similar to RAN node 1 114 or RAN node 2 116. In some aspects, RAN NSF 204 may be similar to RAN NSF2 118 (when RAN node 202 is similar to RAN node 1 114). In some aspects, RAN NSF 204 may be similar to RAN NSF3 120 or RAN NSF4 122 when RAN node 202 is similar to RAN node 2 116. In some aspects, CN NSF 206 may be similar to any of the CN NSF1 108, CN NFS5 110 or CN NSF6 112.

As illustrated, each of the device 106, RAN node 202, RAN NSF 204, and CN NSF 206 may include an NSAP layer. The device 106 may have an NSAP layer 212, and the CN NSF 206 may have an NSAP layer 232. In some aspects, when an NSF (e.g., RAN NSF 204) is located in a RAN node (e.g., RAN node 202), the NFS (e.g., RAN NSF 204) and the RAN node (e.g., RAN node 202) may share same NSAP layer 222. In some aspects, the RAN node 202 may have a separate NSAP layer than the RAN NSF 204, even though the RAN NSF 204 may be located in the RAN node 202.

The NSAP layer runs a protocol to enable communication between a device 106 and an NSF (e.g., CN NSF 206), the communication being related to an NS context. In some aspects, depending on where the NSF is located (e.g., in the RAN 103 or in the CN 104), the NSAP layer may adapt between AS (access stratum) and NAS (non-access stratum).

The NSAP layer 222 may be viewed as an enhanced protocol layer in the RAN node 202. In some aspects, the NSAP layer, in the device 106 and the CN NSFs, may be viewed as replacing the NAS layer.

As may be appreciated by a person skilled in the art, in some aspects the NSAP layer 212 may form part of the protocol stack at the device 106. The device's 106 protocol stack may further include radio resource control (RRC) layer 214, packet data convergence protocol (PDCP) layer 215, radio link control (RLC) layer 216, medium access control (MAC) layer 217, and physical (PHY) layer 218.

In some aspects, the NSAP layer 222 may form the part of the protocol stack at RAN node 202. The protocol stack at RAN node 202 may further include RRC layer 224, PDCP layer 225, RLC layer 226, MAC layer 227, and PHY layer 228.

In some aspects, an NSF may comprise a processing module for processing information received at the NSAP layer. For example, the RAN NSF 204 may comprise a processing module 229 for processing information received at the NSAP layer 222. Similarly, the CN NSF 206 may comprise a processing module 233 for processing information received at the NSAP layer 232.

In some aspects, a device 106 may access a network service with respect to an NS context, by communicating with an NSF that provides access to the network service. The NS context may be related to the device and to the network service. The NSF may maintain the NS context and may be considered as serving the NS context.

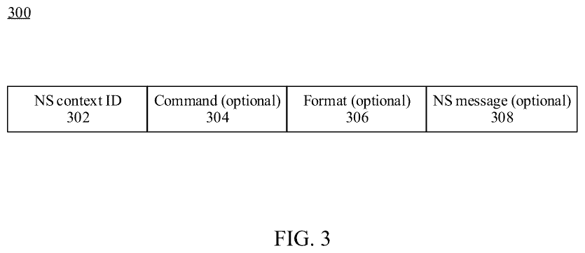

When communicating with the NSF, NSAP messages are exchanged between the device and the NSF. FIG. 3 illustrates an NSAP message, according to an aspect. The NSAP message 300 may include one or more fields indicating one or more of: an NS context ID 302, a command 304, a format 306, and an NS message 308. In some aspects, the one or more fields indicating command 304, format 306, and 308, may be optional.

In some aspects, the field indicating the command 304 may be used to dynamically update the NSAP layer behaviors. For example, an NSF may send an NSAP message comprising a command indication to the device, so that the device may perform one or more operations according to the command to modify the NSAP context locally at the device.

In some aspects, the NS message 308 may also include the NS context ID. The NS context ID may identify the NS context. The NS context may include information identifying the corresponding network service. In some aspects, the NS context may further include information identifying one or more of: a related device, a related network slice, a related system module or service module, a related application, a related data source, a related data network, etc. In some aspects, the format indication 306 may indicate whether the NS message 308 is in the form of a cipher text or a plain text.

In some aspects, when the device 106 communicates with an NSF, NSAP messages are exchanged between the device and the NSF. In some aspects, an NSAP message originated from the device 106 may be referred to as an uplink (UL) message. Whereas, an NSAP message originated from the NSF may be referred to as a downlink (DL) message.

In some aspects, the NSAP message may be transported between the device and the NSF via the serving RAN node of the device. Thus, both UL messages (NSAP message from the device to the NSF) and DL messages (NSAP messages from NSF to the device) may be transported via the serving RAN node of the device.

In some aspects, the NSAP messages may be transported using a radio bearer and an NS session. In some aspects, the radio bearer may be a signaling radio bearer (SRB) or a data radio bearer (DRB). The radio bearer may be between the device and the serving RAN node, and the NS session may be between the serving RAN node and the NSF. In some aspects, one or both of the radio bearer or the NS session may or may not be dedicated to the device.

An NSF serving an NS context may be referred to as a serving NSF, in which the NSF receives and processes service requests associated with the NS context.

In some aspects, the serving NSF may be external to the serving RAN node, in which the NS session may correspond to a communication tunnel (e.g. Ethernet tunnel, IP tunnel, IP/UDP tunnel, IP/TCP tunnel, IP/SCTP tunnel), between the serving RAN node and the serving NSF. The serving NSF may be considered external to the serving RAN, when the serving NSF is a CN NSF or a RAN NSF that is located outside of the serving RAN node. In some aspects, the communication tunnel between the serving RAN node and the serving NSF may be supported by the transport network layer.

In some aspects, the serving NSF may be internal to the serving RAN node, in which the NS session may correspond to an internal transport mechanism of the RAN node. The serving NSF, e.g., RAN NSF 204, may be considered internal to the serving RAN node when the serving NSF is located at or in the serving RAN node, e.g., RAN node 202. The internal transport mechanism of the RAN node may be used to deliver the NSAP messages (or NS messages embedded in the NSAP messages) from the NSAP layer to a module or component (a part of the serving NSF) of the RAN node for processing, e.g., processing module 229.

In some aspects, the internal transport mechanism may be related to communicating the messages over fiber, copper, or bus. In some aspects, the internal transport mechanism may be related to communicating the messages between processes or threads. In some aspects, the internal transport mechanism may be related to communicating the messages via interrupts or function calls.

The NSAP layer (or NSAP) on devices, RAN nodes and NSFs may maintain protocol context which may be referred to as NSAP context.

In some aspects, the NSAP context on a device may include information relating to security context. Information relating to security context may refer to NSAP security context, which may also be known as NSAP security parameters. In some aspect, the NSAP security context may comprise one or more of: a public key, a private key, or a reference (e.g., an ID or an index) pointing to or identifying the public key and the private key. The public key may be referred to as the public key of the device. Similarly, the private key can be referred to as the private key of the device.

In some aspects, the public key may not be necessarily public (or known to the public). For example, the public key may be a secret key. In this context, use of the term ‘public’ is for differentiating the key from the other key (i.e., the private key). In some aspects, the public key and the private key may be the same.

In some aspects, the public key may be used to encrypt the NS message in an UL NSAP message originated from the device. In some aspects, the private key may be used to decrypt the NS message in a DL NSAP message received by the device.

In some aspects, the NSAP context on a device may further include information indicating NS context ID(s) and one or multiple NSAP handling rules associated with each of the NS context ID(s). The one or multiple NSAP handling rules associated with an NS context ID may indicate how to handle NSAP messages associated with the NS context ID. As described herein, the NS context ID identifies an NS context with which the NSAP messages may be associated. In some aspects, the one or multiple NSAP handling rules may include a security indication indicating whether to apply NSAP security on the NSAP messages associated with the NS context ID.

In some aspects, the one or multiple NSAP handling rules may differ from one NS context over another. For example, a first NS context may be associated with a first NSF, and a second NS context may be associated with a second NSF. The first NS context may require that NSAP security should be applied to NSAP messages communicated with the first NSF, whereas the second NS context may not have a similar requirement.

In some aspects, the NSAP context on a RAN node (e.g., RAN node 1 114, RAN node 2 116, or RAN node 202) may include information relating to security context. Information relating to security context may refer to NSAP security context, which may also be known as NSAP security parameters. In some aspect, information relating to security context may be on a per device basis (identified by a device ID). In some aspects, the security context information, per device, may include a DL re-encryption key or a reference (e.g., an ID or an index) pointing to or identifying the DL re-encryption key. The DL re-encryption key can be referred to as the DL re-encryption key of the device. In some aspects, the DL re-encryption key may be used for re-encrypting the NS message in a DL NSAP message, originated from an NSF and targeting the device.

In some aspect, information relating to security context may be on a per NS session basis (identified by an NS session ID). In some aspects, the security context information, per NS session, may include an UL re-encryption key or a reference (e.g., an ID or an index) pointing to or identifying the UL re-encryption keys. The UL re-encryption key can be referred to as the UL re-encryption key of the NS session. In some aspects, the UL re-encryption key may be used for re-encrypting the NS message in an UL NSAP message associated with the NS session, where the NSAP message is originated from the device.

In some aspects, the NSAP context on a RAN node may further include information indicating NS context ID(s) and one or multiple NSAP handling rules associated with each of the NS context ID(s). The one or multiple NSAP handling rules associated with an NS context ID may indicate how to handle an NSAP message associated with the NS context ID. As described herein, the NS context ID identifies an NS context in which the NSAP messages may be associated with. In some aspects, the one or multiple NSAP handling rules may include a security indication, indicating whether to apply NSAP security on the NSAP message. In some aspects, when or if the NSAP message is an UL NSAP message, the one or multiple NSAP handling rules may indicate which NS session (identified by an NS session ID) may be used to transport the NSAP message. In some aspects, when or if the NSAP message is a DL NSAP message, the one or multiple NSAP handling rules may indicate which device (identified by a device ID) the NSAP message may be transported to.

In some aspects, the NSAP context on an NSF (e.g., a CN NSF, a RAN NSF) may include information relating to security context. Information relating to security context may refer to NSAP security context, which may also be known as NSAP security parameters. In some aspects, information relating to security context may be on a per NS session bases (identified by NS session ID). In some aspect, the security context information, per NS session, may include one or more of: a public key and a private key, or a reference (e.g., an ID or an index) pointing to or identifying the public key and the private key. In some aspects, the public key may be referred to as the public key of the NS session. In some aspects, the private key may be referred to as the private key of the NS session.

In some aspects, the public key is not necessarily public (or known to the public). In some aspects, the public key may be a secret key. The use of term ‘public’ in this context is for differentiating the key from the other key (i.e., the private key). In some aspects, the public key and the private key may be the same.

In some aspects, the public may be used to encrypt the NS message in a DL NSAP message originated from an NSF. In some aspects, the private kay may be used to decrypt the NS message in an UL NSAP message received by the NSF.

In some aspects, the NSAP context on the NSF may further include information indicating NS context ID(s) and one or multiple NSAP handling rules associated with each of the NS context ID(s). The one or multiple NSAP handling rules associated with an NS context ID may indicate how to handle an NSAP message associated with the NS context ID. In some aspects, the one or multiple NSAP handling rules may include a security indication, indicating whether to apply the NSAP security on the NSAP messages associated with the NS context ID. In some aspects, when or if the NSAP message is a DL NSAP message, the one or multiple handling rules may indicate which NS session (identified by an NS session ID) may be used to transport the NSAP message.

In some aspects, a device 106 may access a network service with respect to an NS context, via a RAN node and an NSF. The RAN node may be considered to be serving the device. The NSF may be considered to be serving the NS context. The device and the NSF may perform NSAP communication (i.e., exchange NSAP messages) via the serving RAN node. The NSAP layer, at each of the device 106, the serving RAN node, and the NSF, may processes the NSAP messages according to NSAP context, as further described herein.

In some aspects, during the NSAP communication, the device (i.e., the NSAP layer 212 on the device 106) may process an NSAP message. The NSAP message may include an NS context ID and an NS message. In some aspects, the NSAP message may be an UL NSAP message to be sent from the device to the NSF. The UL NSAP message may be sent via the RAN node using a radio bearer. In some aspects the NSAP message may be a DL NSAP message received by the device from the NSF. The DL NSAP message may be received via the RAN node using a radio bearer.

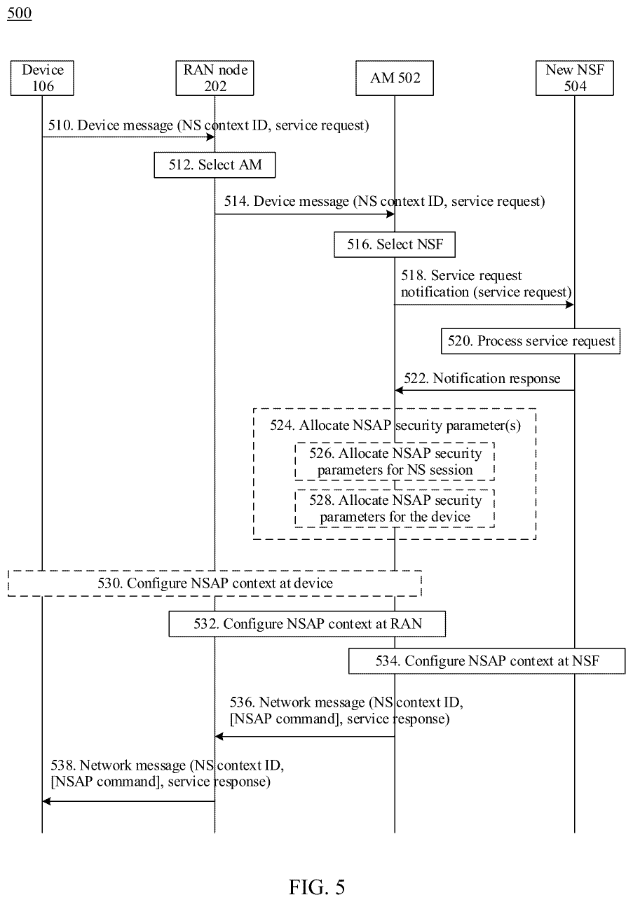

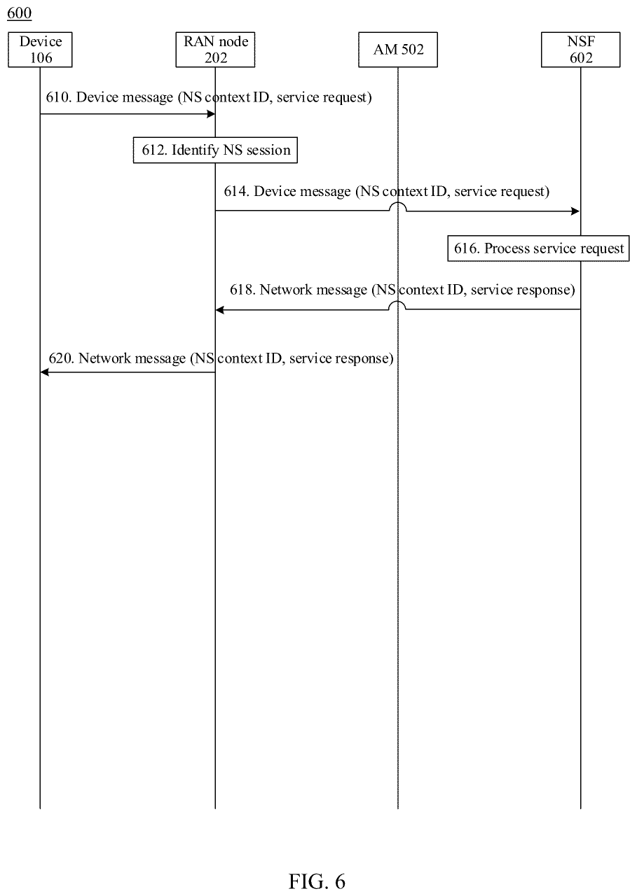

In some aspects, when processing the NSAP message, the device (i.e., the NSAP layer 212 on the device 106) may process the NSAP message according to one or more NSAP message handling rules associated with the NS context ID. As described herein, the one or more NSAP message handling rules may be part of the NSAP context on the device. For example, in reference to FIGS. 5 and 6, before sending the device message 510 and 610 respectively (each an UL NSAP message), the device 106 may process the device message, 610 according to its local NSAP context, as described in one or more aspects herein. Similarly, in reference to FIGS. 5 and 6, after receiving the network message 538 and 620 respectively (each a DL NSAP message), the device 106 may process the network message according to its local NSAP context, as described in one or more aspects herein.

In some aspects in which the NSAP message is an UL NSAP message (e.g., device message 510 of FIG. 5 and device message 610 of FIG. 6), the one or more NSAP message handling rules may indicate that NSAP security should be applied. For example, the one or more NSAP message handling rules may include a security indication indicating that NSAP security should be applied. According to the one or more NSAP message handling rules, the device, via its NSAP layer 212, may cipher (encrypt) the NS message in the NSAP message using the public key of the device. In some aspects, the public key of the device for encryption may be identified or included in the NSAP context. According to the one or more NSAP message handling rules, including the security indication that indicates NSAP security should be applied, the device, via its NSAP layer 212, may further include a format indication in the NSAP message. The format indication may indicate that the NS message in the NSAP message is a ciphertext (or in other words, in the form of a ciphertext).

In some aspects in which the NSAP message is an UL NSAP message (e.g., device message 510 of FIG. 5 and device message 610 of FIG. 6), the one or more NSAP message handling rules may indicate that NSAP security should not be applied. For example, the one or more NSAP message handling rules may include a security indication that indicates that NSAP security should not be applied. According to the one or more NSAP message handling rules, the device may not cipher (encrypt) the NS message in the NSAP message. According to the one or more NSAP message handling rules, the device, via its NSAP layer 212, may include a format indication in the NSAP message indicating that the NS message in the NSAP message is a plaintext (or in other words, in the form of a plaintext).

In some aspects in which the NSAP message is a DL NSAP message (e.g., network message 538 of FIG. 5 and network message 620 of FIG. 6), the one or more NSAP message handling rules may indicate that NSAP security should be applied. According to the one or more NSAP message handling rules, the device, via its NSAP layer 212, may decipher (decrypt) the NS message in the NSAP message using the private key of the device (the private key of the device may be identified or included in the NSAP context) unless the NSAP message includes a format indication indicating that the NS message in the NSAP message is a plain text (or in other words, in the form of plain text). For example, the one or more NSAP message handling rules may include a security indication indicating that NSAP security should be applied, while the NSAP message includes the format indication. The device in this case may not decipher (decrypt) the NS message in the NSAP message as the NS message is a plain text as indicated by the format indication.

In some aspects in which the NSAP message is a DL NSAP message (e.g., network message 538 of FIG. 5 and network message 620 of FIG. 6), the NSAP message may include a format indication indicating that the NS message in the NSAP message is a ciphertext (or is in the form of a ciphertext). In such aspects, whether the one or more NSAP message handling rules indicate to apply NSAP security or not, the device, via its NSAP layer 212, may decipher (decrypt) the NS message in the NSAP message using the private key of the device. The private key of the device may be identified or included in the NSAP context.

In some aspects, the public and private key used by the device, in performing secure NSAP communication according to its one or more NSAP message handling rules, may be allocated by the AM, e.g., at block 528 of FIG. 5, and provided to the device 106, e.g., at block 530 of FIG. 5, as described herein.

In some aspects, during NSAP communication, the NSF (i.e., the NSAP layer on the NSF) may process an NSAP message. For example, in reference to FIG. 5, the AM 502 (which may be an NSF in some aspects), after receiving the device message 514 (an UL NSAP message), may process the device message 514 according to its local NSAP context, as described in one or more aspects herein. Further, in reference to FIG. 6, after receiving the device message 614 (an UL NSAP message), the NSF 602 may process the device message according to its local NSAP context, as described in one or more aspects herein.

Similarly, in reference to FIG. 5, before sending the network message 536 (a DL NSAP message), the AM 502 may process the network message according to its local NSAP context, as described in one or more aspects herein. Further, in reference to FIG. 6, before sending the network message 618 (a DL NSAP message), NSF 602 may process the network message according to its local NSAP context, as described in one or more aspects herein.

The NSAP message may include an NS context ID and an NS message. In some aspects, the NSAP message may be an UL NSAP message (e.g., device message 514 of FIG. 5 or device message 614 of FIG. 6) received by the NSF from the device. The NSF may receive the UL NSAP message via a RAN node using an NS session. In some aspects, the NSAP message may be a DL NSAP message to be sent by the NSF to the device via the RAN node using an NS session. In either case (e.g., UL NSAP message or DL NSAP message), the NS session is associated with the NS context ID, which identifies the NS context.

When processing the NSAP message, the NSF may process the NSAP message according to one or more NSAP message handling rules associated with the NS context ID. In some aspects, the one or more NSAP message handling rules may be part of the NSAP context on the NSF.

In some aspects in which the NSAP message is a DL NSAP message (e.g., network message 536 of FIG. 5 or network message 618 of FIG. 6), the one or more NSAP message handling rules may indicate that NSAP security should be applied. For example, the one or more NSAP message handling rules may include a security indication indicating that NSAP security should be applied. According to the one or more NSAP message handling rules, the NSF, via its NSAP layer, may cipher (encrypt) the NS message in the NSAP message using the public key of the NS session. The public key of the NS session may be identified or included in the NSAP context. In some aspects, the NSF, via its NSAP layer, may, according to the one or more message handling rules, include a format indication in the NSAP message, indicating that the NS message in the NSAP message is a ciphertext (or in other words, in the form of a ciphertext).

In some aspects in which the NSAP message is a DL NSAP message (e.g., network message 536 of FIG. 5 or network message 618 of FIG. 6), the one or more NSAP message handling rules may indicate that NSAP security should not be applied. For example, the one or more NSAP message handling rules may include a security indication indicating that NSAP security should not be applied. According to the one or more NSAP message handling rules, the NSF, via its NSAP layer, may include a format indication in the NSAP message, indicating that the NS message in the NSAP message is a plaintext (or in other words, in the form of a plaintext).

In some aspects in which the NSAP message is an UL NSAP message (e.g., device message 514 of FIG. 5 or device message 614 of FIG. 6), the one or more NSAP message handling rules may indicate that NSAP security should be applied. According to the one or more NSAP message handling rules, the NSF, via its NSAP layer, may decipher (decrypt) the NS message in the NSAP message using the private key of the NS session (the private key of the NS session may be identified or included in the NSAP context) unless the NSAP message includes a format indication that indicates the NS message in the NSAP message is a plaintext (or in other words, in the form of a plaintext). For example, the one or more NSAP message handling rules may include a security indication that indicates to apply NSAP security, while the NSAP message includes the format indication. The NSF in this case does not decipher (decrypt) the NS message in the NSAP message as the NS message is a plain text as indicated by the format indication.

In some aspects in which the NSAP message is an UL NSAP message (e.g., device message 514 of FIG. 5 or device message 614 of FIG. 6), the NSAP message may include a format indication that indicates the NS message in the NSAP message is a ciphertext (or in other words, in the form of a ciphertext). In such aspects, whether the one or more NSAP message handling rules indicate to apply NSAP security or not, the NSF, via its NSAP layer, may decipher (decrypt) the NS message in the NSAP message using the private key of the NS session. The private key of the NS session may be identified or included in the NSAP context.

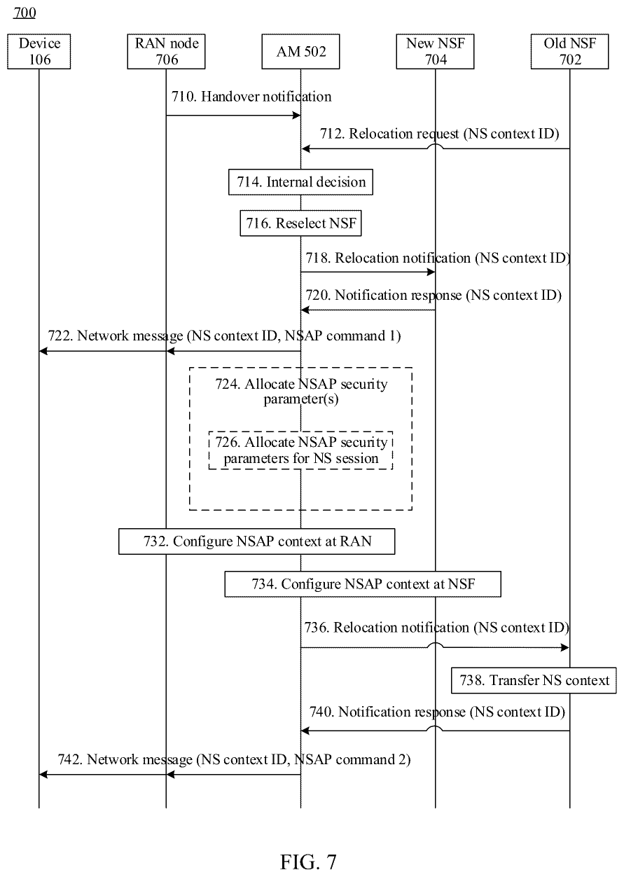

In some aspect, the public key and the private used by the NSF, in performing secure NSAP communication according to its one or more NSAP message handling rules, may be allocated by the AM and provided to the NSF, as described herein, in reference to FIG. 5, at blocks 526 and 534, and in reference to FIG. 7, at blocks 724, 726 and 734.

During NSAP communication, the RAN node (i.e., the NSAP layer 222 on the RAN node) may receive an NSAP message. The NSAP message may include an NS context ID and an NS message. The RAN node may process or handle the NSAP message. For example, in reference to FIGS. 5 and 6, before sending the device message 514 and 614 respectively (each an UL NSAP message), the RAN node 202 may process the device message according to its local NSAP context, as described in one or more aspects herein. Similarly, in reference to FIG. 5 before sending the network message 538, or in FIG. 6 before sending the network message 620 (each a DL NSAP message), the RAN node 202 may process the network message according to its local NSAP context, as described in one or more aspects herein.

In some aspects, the NSAP message may be an UL NSAP message (e.g., device message 510 of FIG. 5 or device message 610 of FIG. 6) received from the device 106. In some aspects, the NSAP message may be a DL NSAP message received from the NSF. The RAN node may transport the NSAP message according to the NSAP context on the RAN node.

In some aspects, the NSAP message may be UL NSAP message (e.g., device message 510 of FIG. 5 or device message 610 of FIG. 6), and the RAN node may identify an NS session corresponding to the NS context ID as indicated in the NSAP context. The RAN node may further transport the NSAP message using the NS session. As the NS session is between the RAN node and the NSF, the NSAP message may thus be transported to the NSF.

In some aspects, the NSAP message may be a DL NSAP message (e.g., network message 538 of FIG. 5 or network message 620 of FIG. 6), and the NSAP message may be associated with an NS session between the RAN node and the NSF (e.g., the NSAP message is received over a tunnel between the RAN node and the NSF, the tunnel corresponding to the NS session). In some aspects, the NSAP context may indicate that the NS session maps to a radio bearer, the radio bearer being associated with the device. Accordingly, the RAN node may transport the NSAP message using the radio bearer as indicated in the NSAP context. Transporting the NSAP message using the indicated radio bearer may cause the NSAP message to be delivered to the device.

In some aspects, the NSAP context may indicate that the device corresponds to an NS context ID. The RAN nodes may transport the NSAP message to the device as indicated in the NSAP context using a radio bearer associated with the device.

In some aspects, before the RAN node transports the NSAP message, the RAN node may identify, in the NSAP context on the RAN node, one or more NSAP message handling rules associated with the NS context ID. The RAN node may process the NSAP message according to the one or more NSAP message handling rules.

In some aspects, UL NSAP messages may be transported using an NS session. In some aspects, in which the NSAP message is an UL NSAP message (e.g., device message 514 of FIG. 5 or e.g., device message 614 of FIG. 6), the one or more NSAP message handling rules may indicate that NSAP security should be applied to NSAP messages associated with the NS context ID. According to the one or more NSAP message handling rules, the RAN node, via its NSAP layer 222, may perform proxy re-encryption on the NS message in the NSAP message (i.e., re-encrypt the NS message) using an UL re-encryption key (the UL re-encryption key may be associated with the NS session; the UL re-encryption key may be identified or included in the NSAP context.), unless the NSAP message includes a format indication that indicates the NS message in the NSAP message is a plaintext (or in other words, in the form of a plaintext). For example, the one or more NSAP message handling rules may include a security indication that indicates to apply NSAP security, while the NSAP message includes the format indication. The device in this case does not perform proxy re-encryption on the NS message in the NSAP message as the NS message is a plain text.

In some aspects in which the NSAP message is an UL NSAP message, e.g., device message 514 of FIG. 5 or device message 614 of FIG. 6, the NSAP message may include a format indication that indicates the NS message in the NSAP message is a ciphertext (or in other words, in the form of a ciphertext). In such aspects, whether the one or more NSAP message handling rules indicate to apply NSAP security or not, the RAN node (via its NSAP layer 222) may perform proxy re-encryption on the NS message in the NSAP message (i.e., re-encrypt the NS message) using the UL re-encryption key. The UL re-encryption key may be identified or included in the NSAP context. The UL re-encryption key may be associated with the NS session.

In some aspects, the UL re-encryption key used by the RAN node, in performing secure NSAP communication according to the one or more NSAP message handling rules, may be allocated by the AM, e.g., at block 526 of FIG. 5, or at block 726 of FIG. 7, and provided to the RAN node, e.g., at block 532 of FIG. 5, or at block 732 of FIG. 7, as described herein.

In some aspects, DL NSAP messages may be transported to the device using a radio bearer. In some aspects in which the NSAP message is a DL NSAP message (e.g., network message 538 of FIG. 5 or network message 620 of FIG. 6), the one or more NSAP message handling rules may indicate that NSAP security should be applied. According to the one or more NSAP message handling rules, the RAN node, via its NSAP layer 222, may perform proxy re-encryption on the NS message in the NSAP message (i.e., re-encrypt the NS message) using a DL re-encryption key of the device (the DL re-encryption key may be identified or included in the NSAP context), unless the NSAP message includes a format indication that indicates the NS message in the NSAP message is a plaintext (or in other words, in the form of a plaintext). For example, the one or more NSAP message handling rules may include a security indication that indicates to apply NSAP security, while the NSAP message includes the format indication. The device in this case does not perform proxy re-encryption on the NS message in the NSAP message as the NS message is a plain text.

In some aspects in which the NSAP message is a DL NSAP message, e.g., network message 538 of FIG. 5 or network message 620 of FIG. 6, the NSAP message may include a format indication that indicates the NS message in the NSAP message is a ciphertext (or in other words, in the form of a ciphertext). In such aspects, whether the one or more NSAP message handling rules indicate to apply NSAP security or not, the RAN node (via its NSAP layer 222) may perform proxy re-encryption on the NS message in the NSAP message (i.e., re-encrypt the NS message) using the DL re-encryption key of the device as identified or included in the NSAP context.

In some aspects, the DL re-encryption key used by the RAN node, in performing secure NSAP communication according to the one or more NSAP message handling rules, may be allocated by the AM, e.g., at block 528 of FIG. 5, and provided to the RAN node, e.g., at block 532 of FIG. 5, as described herein.

In some aspects, the proxy re-encryption performed by the RAN node may be carried out such that the device or the NSF, as the case may be, receiving the NSAP message may decrypt it using their respective private key, without the need to negotiate symmetric keys. In some aspects, the serving NSF may be changed, and in communicating with the new NSF, the device and the new NSF may decrypt NSAP message using their own private key without the need to negotiate symmetric keys. Thus, an aspect of the disclosure may provide for obviating the need to negotiate one or more symmetric keys for encryption or decryption purposes.

In some aspects, a device 106 may be served by an access manage (AM). In some aspects, the AM may be selected by the serving RAN node of the device. In some aspects, the AM may be the default NSAP handling point and responsible for NSF selection and NSAP context management.

When the AM serves the device, the AM may manage the device's registration (or access or attachment) to the communication network. The AM may further manage the device's access to a network service on the control plane of the communication network.

The device may access the network service via an NSF, which provides access to the network service. In some aspects, the NSF may be selected by the AM (e.g., block 516 at FIG. 5, or block 716 at FIG. 7). When the device accesses the network service, the device and the NSF may communicate and exchange NSAP messages.

In some aspects, when the AM manages the device's registration to the communication network, the AM may authenticate and authorize the device to access or attach to the communication network. The AM may allocate a temporary device ID to the device. The temporary device ID may identify the device in the communication network.

In some aspects, the AM may allocate a public key and a private key to the device. For example, in reference to FIG. 5, at block 528, the AM 502 may allocate NSAP security parameter for the device 106, including allocating a public key and a private key to the device 106. The AM may provide the temporary device ID, the public key and the private key to the device. For example, in reference to FIG. 5, at block 530, the AM 502 may configure NSAP context at device 106 by providing the allocated public key and private key to the device 106. In some aspects, the device may use the temporary device ID to access the network service. The device may store the public key and the private key in its local NSAP context as part of the NSAP security context. The device may use the public key and the private key to perform secure NSAP communication, as described above, for accessing the network service.

In some aspects, the AM may further allocate a DL re-encryption key for the device and provide the DL re-encryption key to the serving RAN node (directly or via the device). For example, in reference to FIG. 5, at block 528, the AM 502 may allocate a DL re-encryption key and, further at block 532, the AM may provide the DL re-encryption key to the RAN node 202, as further described herein. The RAN node 202 may store the DL re-encryption key as part of its NSAP security context.

In some aspects, the DL re-encryption key may be generated based on or using the public key of the device. The serving RAN node may associate the DL re-encryption key with the device. The serving RAN node may identify the device using an internal ID, which may be maintained only by the RAN node or within the RAN. The RAN node may store the DL re-encryption key and the association (e.g., a mapping between the key, or a reference to the key, and the internal ID) in its local NSAP context as part of the NSAP security context. The RAN node may use the DL re-encryption key to support secure DL NSAP communication, as described above, from the NSF to the device.

In some aspects, the AM may not provide the DL re-encryption key to the serving RAN node. Instead, the AM provide may provide the public key of the device to the serving RAN node, and the serving RAN node may generate the DL re-encryption key using the public key of the device.

In some aspects, the DL re-encryption key may not be provided from the AM to the serving RAN node. Instead, the device may generate the DL re-encryption key using the public key of the device and provide the DL re-encryption key to the serving RAN node.

In some aspects, the AM may trigger an NS session to be created between the NSF and the serving RAN node of the device. The NS session may be used to support NSAP communication between the device and the NSF, as described herein. The NS session may be identified by an NS session ID, which may be generated by the serving RAN node, the NSF or the AM. For example, in reference to FIG. 5, a selected NSF 504, in processing 520 a service request may establish NS context including generating an NS context ID according to information received in the service request 518, as described herein.

In some aspects, the AM may configure related NS session context (e.g., the NS session ID, routing information, the routing information including information that can be used to reach other end of a tunnel associated with the NS session, such as type of tunnel, protocol type, address, port number, tunnel ID, tunnel end ID) at one or more of: the serving RAN node and the NSF. Some examples of configuring the serving RAN node include one or more operations performed at block 532 in FIG. 5 and at block 732 in FIG. 7. Some examples of configuring an NSF include one or more operations performed at block 534 in FIG. 5 and at block 734 in FIG. 7.

In an aspect, the AM may configure NSAP context at the serving RAN node and at the NSF so that the device and the NSF may perform NSAP communication with each other. The NSAP context at the serving RAN node and at the NSF may be respectively referred to as RAN NSAP context and NSF NSAP context.

In some aspects, the AM may allocate a public key and a private key and associates the keys to the NS session. The AM may provide the public key and the private key to the NSF. The AM may also notify the NSF about the association of the provided keys with the NS session. In some aspects, the association can be in the form of a mapping between the keys (or a reference to the keys) and the NS session ID. The NSF may store the keys and the association in the NSF NSAP context as part of the NSAP security context. The NSF may use the keys to perform secure NSAP communication with the device over the NS session, as described elsewhere in this application. For example, in reference to FIG. 5, at blocks 526 and 534, and in reference to FIG. 7, at blocks 726 and 734, the AM 502 may provide the pair of keys (e.g., the public key and the private key) to the NSF (or the new NSF in FIG. 7), and the NSF may store the pair of keys as part of its NSAP security context.

In some aspects, the AM may allocate an UL re-encryption key and associates the key to the NS session. For example, at block 526 of FIG. 5, or at block 726 of FIG. 7, the AM 502 may allocate NSAP security parameters for NS session, including allocating an UL re-encryption key. The AM may provide the UL re-encryption key to the serving RAN node (directly or via the NSF). For example, at blocks 526 and 532 of FIG. 5, or at blocks 726 and 732 of FIG. 7, the AM 502, after allocating the UL re-encryption key, may provide the UL re-encryption key to the RAN node 202 in FIGS. 5 and 702 in FIG. 7. The respective RAN node may then store the UL re-encryption key as part of its NSAP security context.

The AM may further notify the serving RAN node about the association of the provided key with the NS session. In some aspects, the association can be in the form of a mapping between the key (or a reference to the key) and the NS session ID. The serving RAN node may store the key and the association in the RAN NSAP context as part of the NSAP security context. The RAN node may then use the key to perform secure UL NSAP communication from the device to the NSF, as described elsewhere in this application.

In some aspects, the AM may not provide the UL re-encryption key to the serving RAN node. Instead, the AM may provide the public key of the NS session to the serving RAN node, and the serving RAN node may generate the UL re-encryption key using the received public key of the NS session.

In some aspects, the AM may not provide the UL re-encryption key to the serving RAN node. Instead, the NSF may generate the UL re-encryption key using the public key of the NS session and provide the generated UL re-encryption key to the serving RAN node.

In some aspects, when the AM provides a key (e.g., a re-encryption key, a public key, a private key) or a key pair (e.g., a public key and a private key) to a network entity (e.g., a device, a RAN node, an NSF), the AM may provide the key or the key pair by value (i.e., provide the key or the key pair itself) or by reference (i.e., provide a reference or an index pointing to the key or the key pair). In some aspects, the AM may provide the key or the key pair by reference when the key or the key pair are pre-configured in the network entity. The network entity may then identify the key or the key pair in its configuration using the reference.

In some aspects, the AM may be a default NSAP handling point for the device's access to the network service, before the NSF is selected for the device. For example AM 502 of FIG. 5.

In some aspects, when the AM handles an NSAP message of the device related to the device's access to the network service, the AM may select the NSF for the device. In some aspects, the AM and the NSF may be the same (e.g., when the AM itself offers the network service), and thus the interaction between the AM and the NSF may be an internal process of the AM.

For example, the AM may be an NSF that offers a network service, e.g., a registration service, that the device is accessing. Thus, in some aspects, the AM may select itself depending on the network service that the device is accessing. Accordingly, the NSAP communication between the AM and the device may also need to be secured.

Thus, the AM may also perform the operations described herein between the device and itself (wherein the NSF is the AM itself) for establishing or supporting secure communication, where any interaction between the AM and the NSF is an internal process of the AM. In some aspects, the operations for establishing secure NSAP communication between the device and the AM (also being the NSF) may be performed before the NSAP communication between the device and the AM may begin. For example, in some aspects, the securing NSAP communication between the device and the AM may occur when the AM handles the device's request for accessing the communication network. As such, the communication (in the form of NSAP message exchange) between the device and the AM in relation to the device's access to the network service may be secured.

In some aspects, when the serving RAN node of the device receives an NSAP message from the device, the serving RAN node may identify an NS session that corresponds to the NS context ID in the NSAP message. In some aspects, if the NS session is identified, the serving RAN node may send the NSAP message using the NS session. When sending the NSAP message using the NS session, the serving RAN node may send the NSAP message using a tunnel associated with the NS session. In some aspects, if the NS session is between the serving RAN node and the NSF, the NSAP message may be transported to the NSF.

In some aspects, the serving RAN node may be unable to identify the NS session corresponding to the NS context ID in the NSAP message. In such aspects, the serving RAN node may send the NSAP message to the AM using an NS session between the serving RAN node and the AM, wherein the NS session is for supporting NSAP communication between the device and the AM.

After receiving the NSAP message, the AM may perform one or more of operations according to one or more aspects described herein. For example, the AM may perform one or more of: selecting the NSF (e.g., block 516 in FIG. 5), triggering the creation of an NS session between the serving RAN node and the NSF, and configuring the NSAP context at the serving RAN node and at the NSF as described above.

For example, an AM which receives a request for service (e.g., device message 514 in FIG. 5) may select 516 an NSF for providing the network service.

In some aspects triggering the creation of an NS session between a serving RAN node and the NSF (or selected NSF), may include, sending by the AM 502 a service request notification 518 to a selected NSF, including in the notification the RAN node ID. The NSF may process 520 the service request by updating its local NSAP context.

The NSF may authorize the service request, and if the NS context is not yet established in the NSF, the NSF may establish the NS context (when processing 520 the service request) according to information in the service request notification 518. In some aspects, establishing the NS context may include the NSF generating NS context ID.

In some aspects, the NSF, in processing 520 the service request, may perform one or more NS operations with respect to the NS context, the NS operations identified in NS operation instructions included in the service request 518. The NSF may further associate the NS context with an NS session and update its local NSAP context by storing a mapping between the NS context ID and the NS session ID, as further described herein.

The AM may send the NSAP message to the NSF in the meantime, for example, when the AM configures the NSAP context at the NSF. Subsequent NSAP messages from the device may be transported to the NSF.

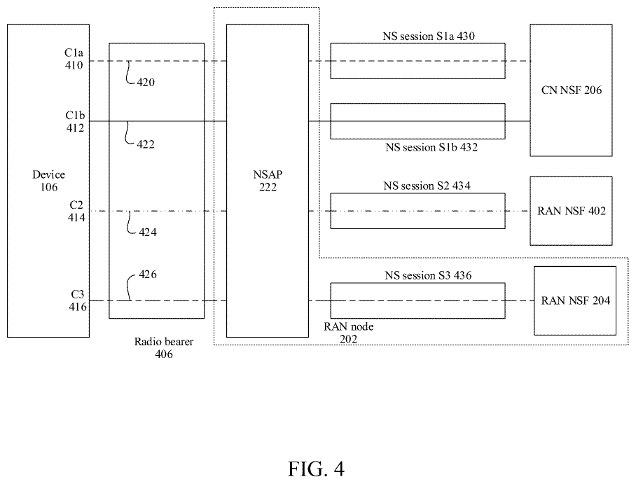

FIG. 4 illustrates an example of handling NSAP messages, according to an aspect. Each line 420, 422, 424, and 426 may indicate a different NS context. For example, line 420 may refers to a first NS context, identified by NS context ID C1a 410, associated with NS session S1a 430. Similarly, line 422 may refer to a second NS context, identified by NS context ID, C1b 412, (different from the first NS context ID, C1a) associated with NS session S1b 432. As illustrated, in some aspects, each of the NS session S1a 430 and NS session S1b 432 may refer to a session between the serving RAN node 202 of the device 106 and a same NSF (e.g., CN NSF 206). In other aspects, each of the NS session S1a 430 and NS session S1b 432 may be associated with different NSFs, where each NSF may be in the RAN 102 or CN 104.

In aspect, line 424 may refer to a third NS context identified by NS context ID, C2 414 associated with NS session S2 434. The NS session S2 434 may refer to a session between the serving RAN node 202 and a RAN NSF 402 that is located outside of the serving RAN node 202. Line 426 may refer to a fourth NS context identified by NS context ID, C3 416, associated with NS session S3 436. The NS session S3 436 may refer to a session between the serving RAN node 202 and a RAN NSF 204 that is at or located within the serving RAN node 202.

The NSAP messages communicated between the device 106 and the serving RAN node 202 may be transported using a radio bearer 406 between the device 106 and the RAN node 202 as illustrated. The RAN node 202 may then send the NS message to the appropriate NSF using an NS session associated with the NS context ID.

In an aspect, when the device 106 wants to access a network service, the device 106 may send an NSAP message to its serving RAN node 202. The NSAP message may include an NS context ID (e.g., C1a 410 or C3 416) and an NS message.

In an aspect, the device 106 may encrypt the NS message using the public key in the NSAP context, if an NSAP message handling rule associated with the NS context ID indicates to apply NSAP security. For example, NS context associated with NS context ID C1a 410 may indicate that NSAP security should be applied. While on the other hand, the NS context associated with NS context ID C3 416 may indicate that NSAP security should not be applied, in which case the NS message may not be encrypted.

In some aspects, the device 106 may include a format indication in the NSAP message, indicating whether the NS message is in the form a cipher text. Thus, in the case of NS context associated with NS context ID C1a 410, the format indication may indicate that the NS message is a in the form of a cipher text. Whereas, in the case of NS context associated with NS context ID C3 416, the format indication may indicate that the NS message is in the form of a plain text (or the format indication field may be empty, which indicates that NS message is plain text).

Depending on the NS context ID in the NSAP message, the RAN node, via its NSAP layer 222) may identify the NS session, (e.g., S1a or S3) corresponding to the NS context ID. The RAN node may then transport the NSAP message to the corresponding NSF using the identified NS session. For example, for NS session associated with NS context ID C1a 410, the RAN node 202 may use NS session S1a 430, and for NS session associated with NS context identified by NS context ID C3 416, the RAN node 202 may use NS session S3 436. In Some aspects, the RAN node 202 may only send the NS message in the NSAP message, instead of the NSAP message, to the appropriate NSF.

In an aspect, the RAN node 202 may re-encrypt the NS message, to be sent to the NSF, using the UL re-encryption key associated with the NS session, if an NSAP handling rule associated with the NS context ID indicates to apply SAP security. For example, in the case of NS context identified with NS context ID C1a 410, an NSAP message handling rule may indicate that NSAP security should be applied. Accordingly, the RAN node 202 may re-encrypt the NS message using an UL re-encryption key associated with the NS session S1a 430.

In some aspects, the NSAP message received by the RAN node 202 may indicate, via a format indication, that the NS message is in the form of a cipher text (or not in the form of a plain text). Based on the format indication, the RAN node 202 may re-encrypt the NS message using an UL re-encryption key associated with the NS session.

In some aspects, the use of the NS session may cause the NSAP message (or the NS message) to be transported to the appropriate NSF, which provides access to the NS and maintains the NS context.

In an aspect, the serving NSF may decrypt the NS message using a private key associated with the NS session, if an NSAP handling rule associated with the NS context ID indicates to apply SAP security (e.g., NS session Sla 430) or if the NSAP message indicates, via a format indication, that the NS message is in the form of a cipher text (or not in the form of a plain text).

In some aspects, the format indication in the NSAP message may take precedence over or override an NSAP message handling rule. For example, the NSAP message handling rule may indicate that NSAP security need not be applied, whereas, the format indication in the NSAP message indicate that the NS message is in the form of a cipher text. According to the format indication, the entity receiving the NSAP message may apply the appropriate NSAP security (e.g., encrypt, re-encrypt, or decrypt as the case may be.

The NSF may perform the necessary NS operations with respect to the NS context as indicated in the NS message.

Similarly, for DL, when an NSF wants to send a NS message related to an NS context to the device, the NSF may send an NSAP message to the RAN node 202 using an NS session corresponding to the NS context ID. In some aspects, the NSAP message may include the NS context ID (e.g., C1a 410 or C3 416) and the NS message. As may be appreciated by a person skilled in the art, the handling of the DL NSAP message may symmetric to that of an UL NSAP message as described herein.

In an aspect, the device 106 may request for or to access a network service by sending a service request to the RAN node 202. The network service may be, for example, a mobility management service, a session management service, a task management service, a policy management service, etc. The network service may be associated with a service context (or scope). In some aspects, the request for a network service may be a request for a plurality of network services.

In some aspects, the device 106 may specify one or multiple service operations related to the network service (e.g., location update for mobility management service, session establishment for session management service, context synchronization for task management service, policy acquisition for policy management service, etc.).

In some aspects, if the service context is not yet created, during the service request procedure, the service context will be created. The one or multiple service operations may be performed with respect to the service context.

FIG. 5 illustrates a procedure for requesting a network service, according to an aspect. The procedure 500 may refer to a network service request procedure in which the RAN node cannot identify an NS session corresponding to the NS context. In an aspect, the procedure 500 may include the device 106 requesting access to the network service (NS) with respect to a NS context, by sending an NSAP message (the NSAP message can be referred to as a second request for an NS) to the RAN node 202. The NSAP message may also be referred to as device message 510. The RAN node 202 receives the device message 510. In an aspect, the device message 510 may include an NS context ID and an NS message. The NS message includes information identifying the NS.

In some aspects, the NS context ID is used for identifying the NS context. In some aspects, the NS context ID may be optional, for example, when the NS context does not exist in the communication network. In some aspects, the NS context ID may be generated by the device 106. In some aspects, the NS context ID may be generated by the communication network (e.g., an NSF selected to serve the NS context may generate the NS context ID) and received by the device 106 from the communication network in a previous procedure.

In some aspects, the NS message may be referred to as a service request. The service request may include NS information and NS operation instruction.

In some aspects, the NS information may describe or indicate at least part of the NS context. In some aspects, the NS information may include the NS context ID. The NS context ID may be optional in the NS information when the NS context does not exist in the communication network and when the NS context ID is to be generated by the communication network (e.g., an NSF selected to serve the NS context).

In some aspects, the NS information may further include information identifying the network service, e.g., a service ID or name. In some aspects, the NS information may further include information identifying the device (e.g., a device ID). In some aspects, the NS information may further include information identifying a network slice (or slice instance), to which the network service is related. In some aspects, the NS information may further include information identifying an application, a mission or a task, to which the network service is related (i.e., one or both of an application/mission/task name or an application/mission/task ID). In some aspects, the NS information may further include information identifying a data network (e.g., DNN) to which the network service is related. In some aspects, the NS information may further include information identifying a sub system or a service module (e.g., a sub system or service module ID) to which the network service is related. In some aspects, the NS information may further include information identifying a specialized network service (e.g., a specialized service name or ID), to which the network service is related.

In some aspects, the NS operation instruction may indicate one or more NS operations to be performed with respect to the NS context. The NS operation instruction may include information identifying the one or more NS operations, and related operation parameters for each identified NS operation. Each of the one or more NS operations may be identified by an NS operation name or ID. In some aspects, the NS operation instruction may be optional in the service request. In aspects in which the NS operation instruction is absent in the service request, the service request may indicate to create or update the NS context in the communication network using the NS information in the service request.

In some aspects, before sending the device message 510 to the RAN node 202, the device may process the device message according to its local NSAP context (a NSAP context on a device), as described elsewhere herein. For example, the device message 510 may be an UL NSAP message, in which the device may processes the device message according to its local NSAP context based on an UL NSAP message as described herein. The NSAP context on a device includes NSAP handling rule(s) associated with the NS context ID. If the security indication included in the rule(s) indicates applying NSAP security, the device will encrypt the device message 510 using the public key of the device as identified or included in the NSAP context, and further include a format indication in the NSAP message, indicating that the NS message in the UL NSAP message is a ciphertext (or in other words, in the form of a ciphertext). Thus, the device message 510 can be referred to as the second request being encrypted with the public key of the device. Specifically, the device encrypts the NS message in the device message 510 using the public key of the device.

In some aspects, the procedure 500 may further include the RAN node 202 selecting 512 an AM 502. In some aspects, if the device 106 is being served by an AM, the RAN node may select the AM serving the device. In some aspects, if the device 106 is not being served by an AM, the AM is selected to serve the device and is selected from those associated with the RAN node 202.

In some aspects, the procedure 500 may further include the RAN node 202 sending the device message 514 (the device message 514 can be referred to as a first request or the device message can be carried on the first request) to the selected AM 202. In some aspects, before sending the device message 514, the RAN node 202 may process the device message 510 which is received from the device according to its local NSAP context, as described elsewhere herein. For example, the device message 514 may be an UL NSAP message, in which the RAN node 202 may processes the device message according to its local NSAP context (NSAP context on the RAN node 202) based on an UL NSAP message as described herein. The NSAP context on a RAN node may include NSAP handling rule(s) associated with the NS context ID, if the rule(s) indicate(s) applying NSAP security on NSAP messages associated with the NS context ID (e.g. by including a security indication that indicates so), unless the device message 510 includes a format indication that indicates the NS message in the device message 510 is a plaintext (or in other words, in the form of a plaintext), perform re-encryption on the device message 510 (i.e. re-encrypt the NS message in the device message 510) using a UL re-encryption key of the NS session. The UL re-encryption key of the NS session is identified or included in the NSAP context. The UL re-encryption key of the NS session can be referred to as a public key related to the AM. It can be understood that the device message 510 may include NS context ID and an encrypted NS message, and the device message 514 may include NS context ID and a re-encrypted NS message. The device message 514 is obtained by re-encrypting the device message 510 with the public key related to the AM.

In some aspects, after receiving the device message 514 from the RAN node 202, the AM 502 may process the device message 514 according to its local NSAP context (NSAP context on the AM), as described herein. For example, the device message 514 may be an UL NSAP message, in which the AM 502 may processes the device message according to its local NSAP context based on an UL NSAP message as described herein. As an example, the AM decrypts the device message 514 using a private key included in the NSAP context on the AM.

In an aspect, the procedure 500 may further include the AM 502 selecting 516 an NSF according to information in the device message 514. In some aspects, the AM 502 may select the NSF using one or both of: a network binding function (NBF) and a network registry function (NRF).

In some aspects, the NBF and the NRF are both in the communication network. The NBF may maintain the binding information. In some aspects, the binding information may indicate which NSF is serving (thus bound to) which NS context, by comprising a mapping between NSF IDs and NS context IDs. The NRF may maintain profile information about NSFs, which includes information for each NSF. In some aspects, profile information for each NSF may include information of one or more network services supported or offered by the NSF, e.g., one or more lists of service names and service IDs. In some aspects, the profile information for each NSF may further include information of service area of the NSF, e.g., a list of RAN node IDs or geographic zone IDs. In some aspects, the profile information for each NSF may further include information related to one or more network slices that the NSF is associated with, e.g., a list of network slice IDs. In some aspects, the profile information for each NSF may further include one or more applications, missions or tasks that the NSF may serve, e.g., a list of application/mission/task names or IDs.

In some aspects, if the device message 514 sent from the RAN node includes the NS context ID, the AM may identify and select the NSF using the NBF. In an aspect, the AM 502 may send the NS context ID to the NBF. In an optional implementation manner, the AM 502 sends a third request to the NBF, the third request includes the NS context ID. If the NBF can identify the NSF according to the binding information, the NBF may respond to the AM 502 with information about the serving NSF (i.e., NSF ID), as an example, the NBF sends a response to the AM, the AM receives the response, wherein the response indicates the NSF. Thereafter, the NSF selected by the AM may be the serving NSF. In some aspects, the NBF may not identify an NSF based on the NS context ID. The NBF may thus indicate to the AM 502 that no serving NSF can be identified.

In some aspects, the AM may select the NSF using the NRF. In an aspect, when selecting the NSF using the NRF, the AM 502 may send the NS information in the service request and the device's location to the NRF. The device's location may be expressed using the ID of the RAN node. In an optional implementation manner, the AM 502 sends a third request to the NRF, the third request includes the location of the device and the NS information. The NRF may select the NSF according to one or more of: the profile information about the NSF, the NS information and the device's location.

The NRF may select the NSF based on any of the following reasons. In some aspects, the NRF may select an NSF based on the NSF offering or supporting the network service as identified in the NS information. In some aspects, the NRF may select an NSF based on the NSF's service area covering the device's location. In some aspects, the NRF may select an NSF based on the location of the NSF. In some aspects, the NRF may select an NSF based on the NSF belonging to the network slice as identified in the NS information. In some aspects, the NRF may select an NSF based on the NSF being configured to serve the application, or mission or task, or the data network, or the sub system, or the service module, or the specialized network service as identified in the NS information.

In some aspects, the NRF may respond to the AM 502 with information about the NSF. The information about the NSF may comprise information identifying the NSF (e.g., NSF ID or address) and location of the NSF (whether the NSF is located in CN or RAN, and if in RAN, ID of the RAN node). As an example, the NRF sends a response to the AM, the AM receives the response, the response indicates the NSF and the location of the NSF.

In some aspects, any two of the network functions (i.e., the AM 502, the NBF and the NRF) may be the same network entity, for example, the NBF and the NRF are the same network entity, or the AM and the NBF are the same network entity, or the AM and the NRF are the same network entity. In aspects in which two of the network functions (i.e., the AM 502, the NBF and the NRF) are the same entity, the interactions between the two network functions may thus be understood to be an internal process within the entity.

In some aspects, all network functions (i.e., the AM 502, the NBF and the NRF) may be the same network entity.

In some aspects, the AM 502 selects the NSF through an other network function, which is not the NBF or the NRF. The other network function may be selected by the AM 502 according to the information in the service request. The AM 502 sends a third request to the other network function, the third request including any of the NS information, the NS context ID, the device's location to the other network function. According to the third request, the other network function selects the NSF and sends a response to the AM 502, the response indicating the NSF. The response sent from the other network function to the AM 502 may further indicate a location of the NSF. The response may include information about the NSF. The information about the NSF may comprise information identifying the NSF (e.g., NSF ID or address) and the location of the NSF (whether the NSF is located in CN or RAN, and if in RAN, ID of the RAN node), as described above. In some aspects, the other network function selects the NSF using the NBF or the NRF, wherein the other network function sends the information received from the AM 502 to the NBF or the NRF and receives the information about the NSF from the NBF or NRF. This can be viewed that the other network function interacts with (uses) the NBF or the NRF on behalf of the AM 502 to select the NSF.

In some aspects, the procedure 500 may further include the AM 502 sending a service request notification 518 to the NSF. The service request notification 518 may include the service request. In some aspects, the service request notification 518 may further includes information about the RAN node 202 (e.g., the RAN node ID).

In some aspects, the procedure 500 may further include the NSF 504 processing 520 the service request. In some aspects, processing the service request may include the NSF 504 updating its local NSAP context, as describe elsewhere herein.

In some aspects, when processing the service request, the NSF 504 may authorize the service request. In an aspect, if the NS context is not yet established in the NSF, the NSF 504 may establish the NS context, according to the NS information in the service request as describe elsewhere herein.

In some aspects, when establishing the NS context, the NSF 504 may store the NS information as part of the NS context. In some aspects, when an NS context ID is to be generated for the NS context by the communication network, the NSF 504 may further generate the NS context ID as describe elsewhere herein.

In some aspects, if the service request includes the NS operation instruction, when processing the service request, the NSF 504 may perform the one or multiple NS operations identified in the NS operation instruction with respect to the NS context, using corresponding parameters that are included in the NS operation instruction as describe elsewhere herein.

In some aspects, the NSF 504 may associate the NS context with an NS session. The NSF 504 may further update its local NSAP context accordingly, e.g., by storing a mapping between the NS context ID and an NS session ID in the NSAP context as describe elsewhere herein. The NS session ID may identify the NS session. The NS session may be between the RAN node and the NSF and is for the device. In some aspects, the NS session may be an existing NS session (if one exists) or a newly created NS session (otherwise). In some aspects, the NS session ID may be generated by the NSF when the NSF creates the NS session.

In some aspects, the procedure 500 may further include the NSF 504 responding to the service notification by sending a service response or notification response 522 to the AM 502. The notification response 522 may include a service response. The service response may correspond to the service request and indicate that the service request has been accepted.

In some aspects, the NSF 504 may inform the AM 502 about the association between the NS context and the NS session, by including the NS context ID and the NS session ID in the service response or notification response 522. In some aspects, the notification response 522 may further include an indication, the indication indicating whether the NS session is a newly created NS session or whether NSAP security parameters are needed for the NS session. In some aspects, the indication indicating whether the NS session is a newly created NS session may be equivalent to an indication indicating whether NSAP security parameters are needed for the NS session. The AM 502 may according to this indication determine whether to perform operations at block 524 (i.e., whether to allocate NSAP security parameters for one or more of: the NS session and the device) as further described herein.

In some aspects, the NSF 504 may allocate routing information for the NS session and includes the routing information in the service response or notification response 522. The routing information may specify how to communicatively reach the NSF for the NS session.

In some aspects, the procedure 500 may further include, one or more operations in reference to block 524 relating to allocation of NSAP security parameters, by the AM 502. In some aspects, the AM 502 may determine whether to apply NSAP security to the NS context or not, according to the location of the NSF. In some aspects, if the NSF is located in the CN (e.g., a CN NSF), the AM 502 may determine to apply NSAP security to the NS context. In some aspects, if the NSF is located in the RAN (i.e., if the NSF is a RAN NSF), the AM 502 may determine not to apply NSAP security. In some aspects, if the NSF is located in the RAN, but not inside the serving RAN node, the AM 502 may determine to apply NSAP security. In some aspects, the AM 502 may decide according to local configuration, e.g., as indicated in the local configuration.

If the AM 502 determines to apply NSAP security to the NS context, the AM 502 may allocate NSAP security parameters to support secure NSAP communication related to the NS context between the device and NSF, as described in reference to block 526 and 528. If the AM 502 determines not to apply NSAP security to the NS context, the AM 502 may skip operations performed in reference to block 526 and 528.

In some aspects, the one or more operations at block 526 may include the AM 502 allocating NSAP security parameters for NS session. In some aspects, the NSAP security parameters for the NS session may comprise a first pair of keys (e.g., a NSF public key and a NSF private key) and an UL re-encryption key. The UL re-encryption key may be related to the public key in the first pair of keys, e.g., being derived or generated based on the public key in the first pair of keys. In some aspects, AM 502 may provide the first pair of keys to NSF through an NSF configuration request, and the NSF may store the received first pair of keys as part of its NSAP security context as described elsewhere herein, and further described in reference to block 534. The first pair of keys may be used by the NSF to perform secure NSAP communication with the device, as described elsewhere herein. The NSF configuration request further includes one or more of: an ID of the RAN node, a command indicating whether to apply NSAP security to the NS context. If the NSF receives the NSF configuration request, the NSF sends an NSF response indicating receipt of the NSF configuration request to the AM.

In some aspects, AM 502 may provide the UL re-encryption key to RAN node 202 and the RAN node 202 may store the UL re-encryption key as part of its NSAP security context, as describe elsewhere herein and further described in reference to block 532. The UL re-encryption key may be used by the RAN node to support secure NSAP communication in the UL direction from the device to the NSF, as described herein. As an example, the AM provides the UL re-encryption key through a RAN configuration request, the RAN configuration request may further include one or more of: the NS context ID, a NS session ID, a NSF ID or address, routing information for reaching the NSF, a command indicating whether to apply NSAP security to the NS context. If the RAN node receives the RAN configuration request, the RAN node sends a RAN response indicating receipt of the RAN configuration request to the AM.

In some aspects, the AM 502 may perform one or more operations at block 526 according to the indication in the received notification response 522. If the indication indicates the NS session is a newly created NS session or NSAP security parameters are needed for the NS session, the AM 502 may perform the operations at block 526. Otherwise, AM 502 may skip the operations at block 526.

In some aspects, the AM 502 may perform one or more operations at block 528 relating to allocation of NSAP security parameters for the device. The NSAP security parameters for the device may comprise a second pair of keys (e.g., a device public key and a device private key) and a DL re-encryption key. The DL re-encryption key may be related to the public key in the second pair of keys, e.g., being derived or generated based on the public key in the second pair of keys. In some aspects, the AM 502 may provide the second pair of keys to the device through the RAN node, and the device may store the second pair of keys as part of its NSAP security context, as described herein and further described in reference to block 530. In some aspects, the AM sends a device key message to the RAN node, the device key message includes at least one of the device public key and the device private key, then the RAN node provides the device public key and/or the device private key to the device. If the RAN node receives the device key message, the RAN node sends an acknowledgement of receipt of the device key message. In some aspects, the second pair of keys may be used by the device to perform secure NSAP communication with the NSF, as described herein. In some aspects, AM 502 may provide the DL re-encryption key to the RAN node, and the RAN node may store the DL re-encryption key as part of its NSAP security context, as described herein and further described in reference to block 530. In some aspects, the DL re-encryption key may be used by the RAN node 202 to support secure NSAP communication in the DL direction from the NSF to the device, as described herein. As an example, the AM provides the DL re-encryption key through the RAN configuration request.

In some aspects, the NSAP context on the AM may indicate whether NSAP security context has been established in the device or not. In some aspects, the AM 502 may perform operations at block 528 only if the NSAP context on the AM indicates that NSAP security context has not been established in the device.

In some aspects, the procedure 500 may further comprise one or more operations performed at block 530. Block 530 may be related to configuration of NSAP context at the device. In aspect, the AM 502 may provide the second pair of keys to the device via the RAN node 202. In some aspects, the second pair of keys may be in the form of a value or a reference. In some aspects, the AM 502 and the device 106 may negotiate, e.g., through NSAP communication, a secret key. The AM 502 may use the secret key to securely send the second pair of keys to the device (e.g., as part of an NSAP message sent to the device) when the second pair of keys are provided to the device by value. In some aspects, after receiving the second pair of keys, the device 106 may send an acknowledgement to the AM (e.g., as part of an NSAP message sent to the AM) to confirm the recipient. According to the acknowledgement, the AM 502 may recognize that NSAP security context has been established in the device. The AM 502 may then update its local NSAP context accordingly.

In some aspects, the one or more operations performed at 530 may be integrated with operations performed in sending the network message 536 and operations performed in sending the network message 538, as further described herein.

In some aspects, operations performed at block 530 may be optional, for example, when the AM 502 does not perform the operations at block 528.

In some aspects, the procedure 500 may further include one or more operations performed at block 532. Block 532 may relate to configuration of NSAP context at RAN node. In an aspect, the AM 502 may configure the RAN node 202 by sending a configuration request to the RAN node 202. In some aspects, the configuration request sent to the RAN node may be referred to the RAN configuration request. In an aspect, the AM 502 may inform the RAN node 202 of the association between the NS context and the NS session, by including the NS context ID and the NS session ID in the configuration request. In some aspects, the AM 502 may include information about the NSF (e.g., NSF ID or address) in the configuration request. In some aspects, if the AM 502 receives the routing information for the NS session in the notification response 522 (from NSF), the AM 502 may include the routing information in the configuration request.

In some aspects, the AM 502 may notify the RAN node 202 on whether to apply NSAP security to the NS context, which is identified by the NS context ID. The AM 502 may do so by including an NSAP command in the configuration request, wherein the NSAP command indicates whether to apply NSAP security to the NS context identified by the NS context ID.

In some aspects, the one or more operations at block 532 may further include the AM 502 providing the UL re-encryption key to the RAN node 202. The UL re-encryption key may be allocated via operations performed at block 526.

In some aspects, if the AM 502 performs the one or more operations at block 528 (e.g., allocate NSAP security parameters for the device) and allocates the DL re-encryption key, the AM 502 may also provide the DL re-encryption key to the RAN node in performing operations at block 532.

In some aspects, the AM 502 may provide the UL re-encryption key and the DL re-encryption key to the RAN node in the form of value or reference, by including the keys or references to the keys in the configuration request.

In some aspects, after receiving the configuration request, the RAN node 202 may store the information about the NSF and the routing information (if it is included in the configuration request) as part of the NS session context associated with the NS session identified by the NS session ID.

As also discussed elsewhere herein the NSF serving an NS context receives and processes service requests associated with the NS context. The NS context may include information identifying the corresponding network service. In some aspects, the NS context may further include information identifying one or more of: a related device, a related network slice, a related system module or service module, a related application, a related data source and a related data network.

In addition, and also as discussed elsewhere herein, a NS session is used to transport messages. The NS session context of the NS session basically describes how to transport the message. For example, the NS session context can include one or more of the NS session ID, routing information, the routing information including information that can be used to reach other end of a tunnel associated with the NS session, such as type of tunnel, protocol type, address, port number, tunnel ID and tunnel end ID.

The RAN node 202 may update its local NSAP context according to the configuration request as follows.

In some aspects, the RAN node 202 may store the association between the NS context ID and the NS session ID in the NSAP context. The RAN node 202 may associate the UL re-encryption key with the NS session ID and store the association and the UL re-encryption key (or reference to the UL re-encryption key) in the NSAP context.

In some aspects, if the configuration request includes the DL re-encryption key, the RAN node 202 may associate the DL re-encryption key with the device and store the association and key in the NSAP context.

In some aspects, the RAN node may also update its local NSAP context according to the NSAP command in the configuration request. The RAN node may record or store whether to apply NSAP security to the NS context, as indicated in the NSAP command, in its local NSAP context. In some aspects, the RAN nodes may record or store the information (referring to whether to apply NSAP security to the NS context) in an NSAP handling rule associated with the NS context ID, in the form of a security indication.

In some aspects, the RAN node 202 may optionally acknowledge the configuration request by sending a RAN response or a configuration response to the AM 502 indicating receipt of the RAN configuration request. The AM 502 may accordingly receive the RAN response or the configuration response.

In some aspects, the procedure 500 may include one or more operations performed at block 534. In an aspect, at block 534, the AM 502 may configure the NSF by sending a configuration request to the NSF. In some aspects, the configuration request sent to the NSF node may be referred to an NSF configuration request. The AM 502 may include information about the RAN node (e.g., the RAN node ID) in the configuration request if the information is not provided to the NSF in the service request notification 518.

In some aspects, the AM 502 may notify the NSF whether to apply NSAP security to the NS context, which is identified by the NS context ID. The AM 502 may do so by including the NS context ID and an NSAP command in the configuration request, wherein the NSAP command indicates whether to apply NSAP security to the NS context identified by the NS context ID.

In some aspects, the AM 502 may provide the first pair of keys to the NSF in the form of value or reference, e.g., by including the first pair of keys or a reference to the first pair of keys in the configuration request.

In some aspects, the NSF 504 may process the configuration request. When processing the configuration request, the NSF 504 may store the information about the RAN node (if it is included in the configuration request) as part of the NS session context associated with the NS session identified by the NS session ID. In some aspects, the NSF 504 may further associate the first pair of keys with the NS session ID and store the association and the keys (or reference to the keys) in its local NSAP context.

In some aspects, the NSF may also update its local NSAP context according to the NSAP command in the configuration request. The NSF may record or stores whether to apply NSAP security to the NS context, as indicated in the NSAP command, in its local NSAP context. In some aspects, the NSF may record or store the information (referring to whether to apply NSAP security to the NS context) in an NSAP handling rule associated with the NS context ID, in the form of a security indication.

In some aspects, the NSF may optionally acknowledge the configuration request by sending, to the AM, an NSF response or a configuration response indicating receipt of the NSF configuration request. The AM may accordingly receive the NSF response (or the configuration response).

In some aspects, the one or more operations performed at block 534 may be integrated with operations performed: in sending the service request notification 518, processing 520 the servicer request, and sending the notification response 522. For example, in an aspect, the configuration request may be integrated with the service request notification 518, and the configuration response may be integrated with the notification response 522. Similarly, the NSF's processing of the configuration request may be integrated with NSF's processing 520 of the service request (referring to operations at block 520). In such aspects, operations at block 524 may be performed before step 518 and after step 514, and before or after step 516.

In some aspects, the procedure 500 may further include the AM 502 sending an NSAP message to the RAN node. In some aspects, the NSAP message may be a response message to the request or device message 514. The NSAP message may include the NS context ID and the service response. The service response may be included in the NSAP message as, or as part of an NS message. In some aspects, the NSAP message may be referred to as network message 536.

In some aspects, the AM 502 may notify the RAN node 202 whether to apply NSAP security to the NS context, which is identified by the NS context ID. The AM 502 may do so by including an NSAP command in the network message, wherein the NSAP command indicates whether to apply NSAP security to the NS context identified by the NS context ID.

In some aspects, before sending the network message 536 to the RAN node 202, the AM 502 may process the network message according to its local NSAP context, as described elsewhere herein.

In some aspects, the one or more operation performed in sending the network message 536 may be integrated with operations performed at block 532, e.g., being integrated with the configuration request sent from the AM to the RAN node.

In some aspects, the procedure 500 may further include the RAN node 202 sending the network message 538 to the device 106. In some aspects, before sending the device message 538, the RAN node 202 may process the network message according to its local NSAP context, as described herein. After receiving the network message 538 from the RAN node 202, the device 106 may process the network message 538 according to its local NSAP context as described herein. The device 106 may retrieves the service response from the network message 538.

In some aspects, the device 106 may update its local NSAP context according to the network message 538. The device may record or stores whether to apply NSAP security to the NS context, as indicated in the network message (in some embodiments, as indicated in the NSAP command in the network message), in its local NSAP context. In some aspects, the device may record or store the information (referring to whether to apply NSAP security to the NS context) in an NSAP handling rule associated with the NS context ID, in the form of a security indication.

According to some aspects, e.g., the procedure 500, NSAP context may be established at the device, RAN node and NSF so that direct communication between the device and the NSF may take place with NSAP security activated as needed.

In some aspects, the device 106 may access a network service with respect to an NS context by sending a service request to an NSF that serves the NS context. The service request may be sent via an NSAP message, referred to as device message. The device message may include the NS context ID and the service request. The device may send the device message to the RAN node. The RAN node may process the device message and sends it to the NSF using an NS session corresponding to the NS context. The NSF may process processes the service request and sends a service response back to the device. The service response may be transported to the device also via an NSAP message, referred to as network message. NSAP security may be applied on the device message and the network message, as described elsewhere herein.

FIG. 6 illustrates another procedure for request a network service, according to an aspect. The procedure 600 may refer to a network service request procedure in which the RAN node identifies an NS session corresponding to the NS context.

In an aspect, the procedure 600 may include the device 106 requesting access to the NS with respect to an NS context, by sending an NSAP message to the RAN node 202. The NSAP message may be referred to as device message 610. In an aspect, the device message 610 may include an NS context ID and an NS message. The NS message may be referred to as service request. The NS may include NS information and NS operation instruction.

In some aspects, the one or more operations performed by device 106 in sending device message 610 in procedure 600 may be similar to the one or more operations performed by the device 106 in sending the device message 510 in the procedure 500.

In some aspects, the procedure 600 may further include one or more operations at block 612. In an aspect, the RAN node 202 may identify, select or determine the NS session that is associated with the NS context ID, as indicated in its local NSAP context.

In some aspects, the procedure 600 may further include the RAN node 202 transporting the device message 614 using the NS session. In some aspects, before transporting the device message 614, the RAN node 202 may processes the device message according to its local NSAP context, as described elsewhere herein. The RAN node 202 may then transport the device message 614 to the NSF 602 associated with the NS session.

In some aspects, the procedure 600 may further include one or more operations at block 616. In some aspects, at block 616, the NSF 602 may process the device message according to its local NSAP context, as described elsewhere herein. The NSF 602 may retrieve the service request from the device message.

In some aspects, the NSF 602 may process the service request. When processing the service request, the NSF 602 may authorize the service request. The NSF 602 may further update the NS context according the NS information described in the service request. In some aspects, if the service request includes the NS operation instruction, when processing the service request, the NSF 602 may perform the one or multiple NS operations identified in the NS operation instruction with respect to the NS context, using corresponding parameters that are included in the NS operation instruction.

In some aspects, the procedure 600 may further include the NSF 602 responding to the service request by sending an NSAP message using the NS session over which the NSF received the device message. The NSAP message may include the NS context ID and a service response. The service response may indicate that the service request has been accepted. The NSAP message may be referred to as network message 618.

In some aspects, before sending the network message 618, the NSF 602 may process the network message according to its local NSAP context, as described elsewhere herein.

In some aspects, the procedure 600 may further include the RAN node 202 sending the network message 620 to the device 106. In some aspects, before sending the network message, the RAN node 202 may process the network message according to its local NSAP context, as described elsewhere herein.

In some aspects, after receiving the network message from the RAN node 202, the device 106 may process the network message 620 according to its local NSAP context as described elsewhere herein. In some aspects, the device 106 may retrieve the service response from the network message 620.

According to some aspects, e.g., the procedure 600, a device may directly communicate with an NSF (via the RAN node, but without involving other network entities in the communication network). As such, the communication between the device and the NSF may experiences less delay and less overhead compared to prior arts.

In some aspects, when an NSF is serving an NS context, the NSF is playing the role of a serving NSF (i.e., the serving NSF role) for the NS context, and receives and processes service requests associated with the NS context. An NSF playing the serving NSF role for the NSF context may be referred to as the serving NSF of the NS context. The serving NSF role for the NS context can be relocated from one NSF to another NSF, which may be referred to as NSF relocation.

In some aspects, NSF relocation for the NS context may happen, for example, when a device that the NS context is associated with moves and is handed over to a new RAN node. In some aspects, NSF relocation for the NS context may happen when the serving NSF of the NS context is overloaded (e.g., serving a number of NS contexts, and the number is beyond a threshold value or not below a threshold value). In some aspects, NSF relocation for the NS context may happen when the network condition changes (e.g., delay, rate, throughout, delay jitter), where the network condition refers to the condition between a device that the NS context is associated with and the NSF.

In some aspects, during an NSF relocation, a new NSF may be selected to serve the NS context, and the NS context may be transferred from an old NSF (which plays the serving NSF role before the NSF relocation) to the new NSF. After the NSF relocation, the new NSF may start to serve the NS context and becomes the serving NSF, and service requests associated with the NS context are transported to the new NSF.

FIG. 7 illustrates a procedure for NSF relocation, according to an aspect. The procedure 700 relates to relocation of NSF based on a trigger. In an aspect, procedure 700 may include the AM 502 receiving a trigger for relocating the serving NSF of an NS context. In some aspects, the trigger may be related to handover, e.g., a handover notification 710 received from a RAN node 706, which in some embodiment may be the target RAN node of the handover and in some embodiments may be the source RAN node of the handover.

In some aspects, the trigger may be from the old NSF 702 (i.e., the NSF currently serving the NS context). For example, the trigger may be a relocation request 712 received from the old NSF 702, the request indicating the need of NSF relocation or reselection. The Relocation request may indicate the NS context ID. The old NSF 702 may be the NSF 504 in FIG. 5 or the NSF 602 in FIG. 6.

In some aspects, the trigger may be related to an internal decision 714 of the AM 502. For example, the AM 502 may decide to perform NSF reselection for one or more reasons e.g., for balancing work load on NSFs, to reduce network congestion, etc.

In some aspects, the procedure 700 may include the AM 502 reselecting 716 an NSF to serve the NS context. The reselected or selected NSF may be denoted as new NSF 704.

In some aspects, the AM 502 may reselect the NSF, i.e., the new NSF 704, using the NRF. In some aspects, one or more operations involved in reselecting NSF using the NRF in procedure 700 may be similar to one or more operations involved in selecting 516 NSF using NRF in procedure 500. In some aspect, NBF may not be used for the reselection 716 of the new NSF 704 in procedure 700, since no binding yet exists between the new NSF 704 and the NS context. Accordingly, in some aspects, the reselection 716 of the new NSF, via the NRF, may be done to create a binding so that the serving NSF role may be relocated from the old NSF 702 to the new NSF 704.

In some aspects, the procedure 700 may further include the AM 502 notifying the new NSF 704 that the new NSF is reselected to serve the NS context, by sending a relocation notification 718 to the new NSF 704. In some aspects, the relocation notification may include the NS context ID. In some aspects, the relocation notification may further include information about the old NSF, e.g., ID or address of the old NSF.

In some aspects, according to the relocation notification 718, the new NSF 704 may associate the NS context with an NS session and updates its local NSAP context accordingly. For example, the new NSF 704 may store a mapping between the NS context ID and an NS session ID in the NSAP context. The NS session ID may identify the NS session. The NS session may be between the RAN node and the NSF 704 and is for the device 106. In some aspects, the NS session is an existing NS session (if one exists). In some aspects, the NS session is a newly created NS session (otherwise). In some aspects, the NS session ID may be generated by the NSF when the NSF creates the NS session.

In some aspects, the procedure 700 may further include the new NSF 704 responding to the relocation notification by sending a notification response 720 to the AM 502.

In sending the notification response 720, the new NSF 704 may inform the AM about the association between the NS context and the NS session, by including the NS context ID and the NS session ID in the notification response. In some aspects, the notification response 720 may further include an indication, the indication implying whether the NS session is a newly created NS session or whether NSAP security parameters are needed for the NS session. In some aspects, the AM will according to this indication determine whether to perform one or more operations at block 724 (i.e., whether to allocate NSAP security parameters for the NS session) as further described herein.

In some aspects, the new NSF 704 may allocate routing information for the NS session and include the routing information in the notification response 720. The routing information may specify how to communicatively reach the NSF 704 for the NS session.

In some aspects, the procedure 700 may further include the AM 502 sending an NSAP message (e.g., network message 722) to the device. The NSAP message may include the NS context ID and an NSAP command 1. The NSAP command 1 may indicate to suspend (or pause or stop) NSAP communication associated with the NS context ID.

In some aspects, according to the NSAP message (in particular, the NSAP command 1 in the NSAP message), the device 106 may suspend (or pause or stop) NSAP communication associated with the NS context ID, e.g., stop processing UL NSAP messages that include the NS context ID, buffer (without sending or transmitting) UL NSAP messages that include the NS context ID.

In some aspects, the procedure 700 may further include one or more operations at block 724 relating to allocation of NSAP security parameters. In some aspects, the one or more operations at block 724 may be similar to one or more operations at block 524 of procedure 500. For example, the one or more operations at block 724 may relate to allocation of NSAP security parameters for NS session, at block 726, which may be similar to the one or more operations at block 526, relating to allocation of NSAP security parameters for NS session, of procedure 500.

In some aspects, the one or more operations at block 724 may include the AM 502 determining whether to apply NSAP security to the NS context or not, according to the location of the NSF. In some aspects, if the NSF is located in the CN (e.g., a CN NSF), the AM 502 may determine to apply NSAP security to the NS context. In some aspects, if the NSF is located in the RAN (i.e., if the NSF is a RAN NSF), the AM 502 may determine not to apply NSAP security. In some aspects, if the NSF is located in the RAN, but not inside the RAN node 706 (which may be the service RAN node of the device 106 in some aspects), the AM 502 may determine to apply NSAP security. In some aspects, the AM 502 may decide according to local configuration, e.g., as indicated in the local configuration.

If the AM 502 determines to apply NSAP security to the NS context, the AM 502 may allocate NSAP security parameters to support secure NSAP communication related to the NS context between the device and NSF, as described in reference to block 726. If the AM 502 determines not to apply NSAP security to the NS context, the AM 502 may skip operations performed in reference to block 726.

In some aspects, the one or more operations at block 724 may involve one or more operations at block 726 relating to allocation of NSAP security parameters for the NS session. In some aspects, the one or more operations at block 726 may be similar to the one or more operations performed in reference to block 526, in procedure 500, relating to the allocation of NSAP security parameters for NS session.

In some aspects, the one or more operations at block 726 may include the AM 502 allocating NSAP security parameters for the NS session. In some aspects, the NSAP security parameters for the NS session may comprise a first pair of keys (e.g., a public key and a private key) and an UL re-encryption key. The UL re-encryption key may be related to the public key in the first pair of keys, e.g., being generated or derived based on the public key in the first pair of keys. In some aspects, AM 502 may provide the first pair of keys to NSF 704, and the NSF 704 may store the received first pair of keys as part of its NSAP security context as described elsewhere herein, and further described in reference to block 734. The first pair of keys may be used by the NSF to perform secure NSAP communication with the device, as described elsewhere herein. In some aspects, AM 502 may provide the UL re-encryption key to the RAN node 706, and the RAN node may store the UL re-encryption as part of its NSAP security context, as described herein and further described in reference to block 732. The UL re-encryption key may be used by the RAN node to support secure NSAP communication in the UL direction from the device to the NSF, as described herein.

In some aspects, the AM 502 may perform one or more operations at block 726 according to the indication in the received notification response 720. If the indication indicates that the NS session is a newly created NS session or that NSAP security parameters are needed for the NS session, the AM 502 may perform the one or more operations at block 726. Otherwise, AM 502 may skip the operations at block 726.

In some aspects, the procedure 700 may further include one or more operations performed at block 732, relating to configuration of NSAP context at the RAN node. In an aspect, the AM 502 may configure the RAN node 702 by sending a configuration request to the RAN node 702. In an aspect, the AM 502 may inform the RAN node 702 of the association between the NS context and the NS session, by including the NS context ID and the NS session ID in the configuration request. In some aspects, the AM 502 may include information about the NSF (e.g., NSF ID or address) in the configuration request. In some aspects, if the AM 502 receives the routing information for the NS session in the notification response 720 (from NSF), the AM 502 may include the routing information in the configuration request.

In some aspects, the AM 502 may notify the RAN node 702 whether to apply NSAP security to the NS context, which is identified by the NS context ID. The AM 502 may do so by including an NSAP command in the configuration request, wherein the NSAP command indicates whether to apply NSAP security to the NS context identified by the NS context ID.

In some aspects, one or more operations at block 732 may further include the AM 502 providing the UL re-encryption key to the RAN node 702. The UL re-encryption key may be allocated via operations performed at block 726.

In some aspects, the AM 502 may provide the UL re-encryption key and to the RAN node in the form of value or reference, by including the keys or references to the keys in the configuration request.

In some aspects, after receiving the configuration request, the RAN node 702 may store the information about the NSF and the routing information (if it is included in the configuration request) as part of the NS session context associated with the NS session identified by the NS session ID. The RAN node 702 may update its local NSAP context according to the configuration request as follows.

In some aspects, the RAN node 702 may store the association between the NS context ID and the NS session ID in the NSAP context. The RAN node 702 may associate the UL re-encryption key with the NS session ID and store the association and the UL re-encryption key (or reference to the UL re-encryption key) in the NSAP context.

In some aspects, the RAN node may also update its local NSAP context according to the NSAP command in the configuration request. The RAN node may record or store whether to apply NSAP security to the NS context, as indicated in the NSAP command, in its local NSAP context. In some aspects, the RAN node may record or store the information (referring to whether to apply NSAP security to the NS context) in an NSAP handling rule associated with the NS context ID, in the form of a security indication.

In some aspects, the RAN node 702 may optionally acknowledge the configuration request by sending a configuration response to the AM 502.

In some aspects, the procedure 700 may include one or more operations performed at block 734, relating to configuration of NSAP context at the NSF. In an aspect, the one or more operations at block 734 may include the AM 502 configuring the NSF by sending a configuration request to the NSF 704. The AM 502 may include information about the RAN node 706 (e.g., address or ID of the RAN node) in the configuration request if the information is not provided to the NSF in the relocation notification 718. In some embodiments, the information about the RAN node may be provided to the NSF in the relocation notification 718, and the AM 502 may not include the information about the RAN node in the configuration request.

In some aspects, the AM 502 may notify the NSF 704 on whether to apply NSAP security to the NS context, which is identified by the NS context ID. The AM 502 may do so by including the NS context ID and an NSAP command in the configuration request sent to the NSF, wherein the NSAP command indicates whether to apply NSAP security to the NS context identified by the NS context ID.

In some aspects, the AM 502 may provide the first pair of keys to the NSF 704 in the form of value or reference, e.g., by including the first pair of keys or a reference to the first pair of keys in the configuration request.

In some aspects, the NSF 704 may process the configuration request. When processing the configuration request, the NSF 704 may store the information about the RAN node (if it is included in the configuration request) as part of the NS session context associated with the NS session identified by the NS session ID. In some aspects, the NSF 704 may further associate the first pair of keys (which is provided from the AM 502, in the configuration request) with the NS session ID and store the association and the keys (or reference to the keys) in its local NSAP context.

In some aspects, the NSF may also update its local NSAP context according to the NSAP command in the configuration request. The NSF may record or store whether to apply NSAP security to the NS context, as indicated in the NSAP command, in its local NSAP context. In some aspects, the NSF may record or store the information (referring to whether to apply NSAP security to the NS context) in an NSAP handling rule associated with the NS context ID, in the form of a security indication.

In some aspects, the NSF 704 may optionally acknowledge the configuration request by sending a configuration response to the AM 502.

In some aspects, the procedure 700 may further include the AM 502 notifying the old NSF 702 to perform relocation, by sending a relocation notification 736 to the old NSF 702. The relocation notification 736 may include the NS context ID. In some aspects, the relocation notification may further include information about the new NSF, e.g., ID or address of the new NSF.

In some aspects, if the AM received a relocation request 712 from the old NSF 702, the relocation notification 736 may be used as a response to that relocation request 712.

In some aspects, the procedure 700 may further include transfer of NS context 738. According to the relocation notification 736 received from the AM 502, the old NSF 702 may perform NS context transfer 738 with the new NSF 704. In some aspects, transfer of NS context may involve the old NSF 702 sending the NS context to the new NSF 704, directly or via the AM 502.

In some aspects, the procedure 700 may further include the old NSF 702 responding to the relocation notification, by sending a notification response 740 to the AM 502. The notification response 740 may indicate that the NS context has been transferred to the new NSF.

In some aspect, the procedure 700 may further include the AM 502 sending an NSAP message (network message 742) to the device. In some aspects, the NSAP message may include the NS context ID and an NSAP command 2. The NSAP command 2 may indicate that the device may resume (or restart) NSAP communication associated with the NS context ID.

According to the NSAP message (in particular, the NSAP command 2 in the NSAP message), the device 106 may resume (or restart) NSAP communication associated with the NS context ID. For example, the device 106 may perform one or more of: stop buffering UL NSAP messages that include the NS context ID, send buffered UL NSAP messages that include the NS context (if any), and restart or resume processing UL NSAP messages that include NS context.

According to an aspect, the procedure for NSF relocation, e.g., procedure 700, may improve communication efficiency and network performance. NSF relocation may enable a serving NSF to be relocated, according to one or more of: device mobility, NSF loading and network condition. In some aspects, communication efficiency may be improved by allowing shorter communication path as the serving NSF role can be relocated to an NSF that is closer to the device. In some aspects, network performance may be improved by reduced the delay of handling service requests from a device. In some aspects, NSF relocation may enable dynamic activation or deactivation of NSAP security, e.g., when the new NSF's location is different from the old NSF's location (e.g., NSF location changed from CN to RAN or vice versa).

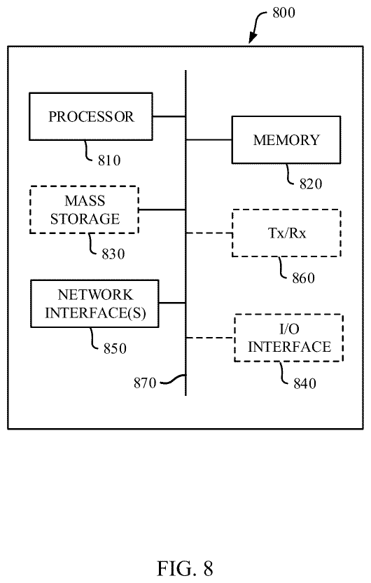

FIG. 8 illustrates an apparatus 800 that may perform any or all of operations of the above methods and features explicitly or implicitly described herein, according to different aspects of the present disclosure. For example, a computer equipped with network function may be configured as the apparatus 800. In some aspects, the apparatus 800 can be the AM 502, the device 106, a RAN node, an NSF (e.g., a RAN NSF or a CN NSF), or any other entity described herein. In some aspect, apparatus 800 can a device that connects to the network infrastructure over a radio interface, such as a mobile phone, smart phone or other such device that may be classified as user equipment (UE). In some aspects, the apparatus 800 may be a Machine Type Communications (MTC) device (also referred to as a machine-to-machine (m2m) device), or another such device that may be categorized as a UE despite not providing a direct service to a user. In some aspects, apparatus 800 may be used to implement one or more aspects described herein. For example, the apparatus 800 may be configured to perform operations performed by one or more entities and functions described herein.

As shown, the apparatus 800 may include a processor 810, such as a Central Processing Unit (CPU) or specialized processors such as a Graphics Processing Unit (GPU) or other such processor unit, memory 820, non-transitory mass storage 830, input-output interface 840, network interface 850, and a transceiver 860, all of which are communicatively coupled via bi-directional bus 870. According to certain aspects, any or all of the depicted elements may be utilized, or only a subset of the elements. Further, apparatus 800 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 820 may include any type of non-transitory memory such as static random-access memory (SRAM), dynamic random-access memory (DRAM), synchronous DRAM (SDRAM), read-only memory (ROM), any combination of such, or the like. The mass storage element 830 may include any type of non-transitory storage device, such as a solid-state drive, hard disk drive, a magnetic disk drive, an optical disk drive, USB drive, or any computer program product configured to store data and machine executable program code. According to certain aspects, the memory 820 or mass storage 830 may have recorded thereon statements and instructions executable by the processor 810 for performing any of the aforementioned method operations described above.

Aspects of the present disclosure can be implemented using electronics hardware, software, or a combination thereof. In some aspects, this may be is implemented by one or multiple computer processors executing program instructions stored in memory. In some aspects, the invention is implemented partially or fully in hardware, for example using one or more field programmable gate arrays (FPGAs) or application specific integrated circuits (ASICs) to rapidly perform processing operations.

It will be appreciated that, although specific aspects of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding aspects, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the aspects of the present invention. For example, such an execution may correspond to a simulation of the logical operations as described herein. The software product may additionally or alternatively include a number of instructions that enable a computer device to execute operations for configuring or programming a digital logic apparatus in accordance with aspects of the present invention.

Although the present invention has been described with reference to specific features and aspects thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A method comprising:
sending, by a device, a second request for a network service (NS) to a radio access network (RAN) node, the second request comprising information identifying the NS and an NS context identifier (ID) identifying the NS context; and
receiving, by the device, a network message comprising the NS context ID and an re-encrypted service response, the re-encrypted service response indicates whether information in the second request has been accepted.

2. The method of claim 1, wherein the network message further comprising a command indicating whether to apply network service access protocol (NSAP) security to the NS context.

3. The method of claim 1, further comprising:
updating, by the device, an NSAP context on the device according to the network message; and
performing, by the device, secure communication with a network service function (NSF) according to the NSAP context on the device, the secure communication related to the NS context.

4. The method of claim 1, wherein the network message further comprises one or more keys for supporting the secure communication, the one or more keys comprising: a device public key and a device private key.

5. The method of claim 4, further comprising:
encrypting, by the device, an uplink (UL) NSAP message using the device public key; and
sending, by the device to the RAN node, the encrypted UL NSAP message.

6. The method of claim 4, further comprising:
receiving, by the device from the RAN node, a re-encrypted downlink (DL) NSAP message; and
decrypting, by the device, the re-encrypted DL NSAP message using the device private key.

7. A method comprising:
receiving, by a radio access network (RAN) node from a device, a second request for a network service (NS), the second request comprising information identifying the NS and an NS context identifier (ID) identifying the NS context;
obtaining, by the RAN rode, a first request by encrypting the second request;
sending, by the RAN node to the AM, the first request for the NS;
receiving, by the RAN node from the AM, a response message including the NS context ID and an encrypted service response, wherein the encrypted service response corresponds to the first request for NS and indicates whether the first request for NS has been accepted; and
sending, by the RAN node, a network message comprising the NS context ID and a re-encrypted service response to the device, the re-encrypted service response is obtained by re-encrypting the encrypted service response.

8. The method of claim 7, wherein the first request is obtained by encrypting the second request with a public key relate to the AM according to an NSAP handling rule of an NASP context on the RAN node.

9. The method of claim 7, further comprising:
receiving, by the RAN node from the AM, a RAN configuration request comprising one or more of: the NS context ID, a NS session ID, a NSF ID or address, a routing information for reaching the NSF, a command indicating whether to apply NSAP security to the NS context, a UL re-encryption key, and a DL re-encryption key.

10. The method of claim 7, further comprising:
receiving, by the RAN node from the AM, a device key message comprising at least one of: a device public key and a device private key; and
sending, by the RAN node to the device, a network message comprising one or more of: the NS context ID, a command indicating whether to apply network service access protocol (NSAP) security to a network service (NS) context identified by the NS context ID, the device public key and the device private key.

11. The method of claim 10, further comprising:
sending, by the RAN node to the AM, an acknowledgement of receipt of the device key message.

12. The method of claim 9, further comprising:
receiving, by the RAN node from the device, an encrypted UL NSAP message;
re-encrypting, by the RAN node, the encrypted UL NSAP message using the UL re-encryption key; and
sending, by the RAN node to the NSF, the re-encrypted UL NSAP message.

13. The method of claim 9, further comprising:
receiving, by the RAN node from the NSF, an encrypted DL NSAP message;
re-encrypting, by the RAN node, the encrypted DL NSAP message using the DL re-encryption key; and
sending, by the RAN node to the device, the re-encrypted DL NSAP message.

14. A method comprising:
sending, by a device, a second request for a network service (NS) to a radio access network (RAN) node, the second request comprising information identifying the NS and an NS context identifier (ID) identifying the NS context;
obtaining, by the RAN rode, a first request by encrypting the second request;
sending, by the RAN node to an access manager (AM), the first request for the NS;
selecting, by the AM, a network service function (NSF) according to the first request;
sending, by the AM to the NSF, a service request notification including information in the first request;
receiving, by the AM from the NSF, a service response corresponding to the service request notification and indicating whether the information in the first request for NS has been accepted;
sending, by the AM to the RAN node, a response message including the NS context ID and an encrypted service response, wherein the encrypted service response is obtained by encrypting the service response; and
sending, by the RAN node to the device, a network message comprising the NS context ID and a re-encrypted service response, the re-encrypted service response is obtained by re-encrypting the encrypted service response.

15. A method comprising,
receiving, by a radio access network (RAN) node from a device, a request message for a network service (NS) associated with an NS context, the request message comprising information identifying the NS and an NS context identifier (ID) identifying the NS context;
determining, by the RAN node, an NS session associated with the NS context ID according to a network service access protocol (NSAP) context on the RAN node;
sending, by the RAN node to a network service function (NSF), the request message using the NS session;
receiving, by the RAN node from the NSF, a response message comprising the NS context and indicating that the request for the NS has been accepted; and
sending, by the RAN node to the device, the response message.

16. The method of claim 15, wherein the request message further comprises one or more of: a service name or ID, a device ID, a slice ID, application ID, a data network ID, one or more NS operations to be performed with respect to the NS context identified by the NS context ID, and an ID for each of the one or more NS operations.

17. The method of claim 15, wherein:
the request message is encrypted via a public key of the device; and
the method further comprising:
re-encrypting, by the RAN node, the encrypted request message using an uplink (UL) re-encryption key based on the NSAP context on the RAN node indicating to apply NSAP security on the request message.

18. The method of claim 15, further comprising:
receiving, by the RAN node from the device, a first indication, the first indication indicates that the request message is encrypted.

19. The method of any one of claims 15, wherein:
the response message is encrypted via a public key of the NSF; and
the method further comprising:
re-encrypting, by the RAN node, the encrypted response message using a downlink (DL) re-encryption key based on the NSAP context on the RAN node indicating to apply NSAP security on the response message.

20. The method of claim 15, further comprising:
receiving, by the RAN node from the device, a second indication, the second indication indicates that the response message is encrypted.
